(19) United States
(12) Patent Application Publication
(10) Pub. No.: US 2022/0057612 A1
(43) Pub. Date: Feb. 24, 2022

(54) PROJECTION OPTICAL SYSTEM AND PROJECTION TYPE DISPLAY DEVICE

(71) Applicant: FUJIFILM Corporation, Tokyo (JP)

(72) Inventor: Yukiko NAGATOSHI, Saitama (JP)

(73) Assignee: FUJIFILM Corporation, Tokyo (JP)

(21) Appl. No.: 17/400,899

(22) Filed: Aug. 12, 2021

(30) Foreign Application Priority Data
Aug. 24, 2020 (JP) 2020-140987

(51) Int. Cl. G02B 13/16; G02B 13/22

(52) U.S. Cl. CPC G02B 13/16; G02B 13/22

(57) ABSTRACT

The projection optical system forms an intermediate image of an image displayed on an image display surface and forms a magnified image by projecting the intermediate image. The projection optical system consists of a first optical system and a second optical system, in order from the reduction side to the magnification side. The first optical system is telecentric on the magnification side, is a coaxial system having a common first optical axis and is non-telecentric on the reduction side. The second optical system is a coaxial system having a common second optical axis and is telecentric on the reduction side. The first optical axis and the second optical axis are parallel.

### CROSS-REFERENCE TO RELATED APPLICATION

The present application claims priority under 35 U.S.C. § 119 to Japanese Patent Application No. 2020-140987, filed on Aug. 24, 2020. The above application is hereby expressly incorporated by reference, in its entirety, into the present application.

### BACKGROUND

### Technical Field

The technique of the present disclosure relates to a projection optical system and a projection type display device.

### Related Art

As the projection optical system, an optical system that forms an intermediate image may be used. As a conventionally known optical system for forming an intermediate image, for example, there is a lens system described in JP2015-179270A below.

In recent years, there has been a demand for a projection type display device that is compact but highly useful. For example, it is desirable that a projection type display device has a so-called lens shift function. The function makes it possible to adjust a position of a projection image on a screen by shifting the projection optical system with respect to an image display element in a direction perpendicular to the optical axis.

### SUMMARY

The present disclosure has been made in view of the above circumstances, and its object is to provide a projection optical system, which is compact, has a lens shift function, and is able to form a favorable projection image, and a projection type display device comprising the projection optical system.

The projection optical system according to one aspect of the technique of the present disclosure is a projection optical system that forms an intermediate image of an image displayed on an image display surface and forms a magnified image by projecting the intermediate image, the projection optical system consisting of, in order from a reduction side to a magnification side along an optical path, a first optical system and a second optical system. The first optical system is telecentric on the magnification side. In a case in which there are a plurality of optical systems which include an optical element closest to the reduction side in the projection optical system and which are telecentric on the magnification side, among the plurality of optical systems, an optical system in which a number of included optical elements is smallest is the first optical system, the first optical system is a coaxial system having a common first optical axis and is non-telecentric on the reduction side, the second optical system is a coaxial system having a common second optical axis and is telecentric on the reduction side, and the first optical axis and the second optical axis are parallel to each other.

Assuming that a distance on the first optical axis from a reduction side focal position of the projection optical system as a base point to a reduction side pupil position of the projection optical system is Exp, a maximum image height on the reduction side of the projection optical system is Y max, and a sign of the distance of Exp on the magnification side from the base point is negative and a sign of the distance of Exp on the reduction side from the base point is positive, the projection optical system of the above aspect preferably satisfies Conditional Expression (1), and more preferably satisfies Conditional Expression (1-1).

−5<Exp/Y max<−0.5 (1)

−4<Exp/Y max<−1 (1-1)

Assuming that an air conversion distance on the first optical axis from a surface closest to the reduction side in the first optical system as a base point to a reduction side focal position of the first optical system is Bf1, an air conversion distance on the first optical axis from a surface closest to the reduction side in the projection optical system as a base point to a reduction side focal position of the projection optical system is Bf, a distance on the first optical axis from the reduction side focal position of the projection optical system as a base point to a reduction side pupil position of the projection optical system is Exp, and a sign of each distance of Bf1, Bf, and Exp on the magnification side from each base point is negative and a sign of the distance of Bf1, Bf, and Exp on the reduction side from each base point is positive, the optical system preferably satisfies Conditional Expression (2), and more preferably satisfies Conditional Expression (2-1).

−1.5<(Bf1−Bf−Exp)/Y max<1.5 (2)

0<(Bf1−Bf−Exp)/Y max<1 (2-1)

Assuming that a maximum image height on the reduction side of the projection optical system is Y max, a focal length of the second optical system is f2, a focal length of the projection optical system is f, a distance in a direction of the second optical axis to a sagittal image plane at an image height of Y max×|f2/f|×0.8 on the reduction side in the second optical system in a case where a paraxial imaging position on the reduction side in the second optical system is set as a base point in a state where the magnified image is located at infinity is Sr, a distance in the direction of the second optical axis to the tangential image plane at the image height of Y max×|f2/f|×0.8 on the reduction side in the second optical system in a case where the paraxial imaging position on the reduction side in the second optical system is set as the base point in a state where the magnified image is located at infinity is Tr, a sign of each distance of Sr and Tr on the magnification side from each base point is negative and a sign of the distance of Sr and Tr on the reduction side from each base point is positive, and each value of f2 and f is set at a wide-angle end in a case where each optical system is a variable magnification optical system, the projection optical system of the above aspect preferably satisfies Conditional Expressions (3) and (4). Further, it is more preferable that Conditional Expressions (3) and (4) are satisfied, and then at least one of Conditional Expressions (3-1) or (4-1) is satisfied.

0.47<Y max/|f| (3)

0<|(Sr+Tr)/2|/Y max<0.1 (4)

0.84<Y max/|f| (3-1)

0<|(Sr+Tr)/2|/Y max<0.05 (4-1)

Assuming that a focal length of the second optical system is f2, a focal length of the projection optical system is f, and each value of f2 and f is set at a wide-angle end in a case where each optical system is a variable magnification optical system, the projection optical system of the above aspect preferably satisfies Conditional Expression (5), and more preferably satisfies Conditional Expression (5-1).

0.6<|f2/f|<4 (5)

1<|f2/f|<3 (5-1)

Assuming that an air conversion distance on the second optical axis from a surface closest to the reduction side in the second optical system as a base point to a reduction side focal position of the second optical system is Bf2, a focal length of the projection optical system is f, a sign of the distance of Bf2 on the magnification side from the base point is negative and a sign of the distance of Bf2 on the reduction side from the base point is positive, and a value of f is set at a wide-angle end in a case where the projection optical system is a variable magnification optical system, the projection optical system of the above aspect preferably satisfies Conditional Expression (6), and more preferably satisfies Conditional Expression (6-1).

−5<Bf2/|f|<5 (6)

−3<Bf2/|f|<3 (6-1)

Assuming that an air conversion distance on the first optical axis from a surface closest to the reduction side in the projection optical system as a base point to a reduction side focal position of the projection optical system is Bf, a focal length of the projection optical system is f, a sign of the distance of Bf on the magnification side from the base point is negative and a sign of the distance of Bf on the reduction side from the base point is positive, and a value of f is set at a wide-angle end in a case where the projection optical system is a variable magnification optical system, the projection optical system of the above aspect preferably satisfies Conditional Expression (7), and more preferably satisfies Conditional Expression (7-1).

0.5<Bf/|f|<10 (7)

0.8<Bf/|f|<5 (7-1)

In the projection optical system of the above aspect, it is preferable that the intermediate image is formed between the first optical system and the second optical system.

A projection type display device according to another aspect of the technique of the present disclosure comprises an image display element that outputs an image and the projection optical system of the above aspect.

The projection type display device according to still another aspect of the technique of the present disclosure includes an image display element that outputs an image, and a projection optical system that forms an intermediate image of the image and forms a magnified image by projecting the intermediate image. The projection optical system consists of a first optical system and a second optical system, in order from a reduction side to a magnification side along an optical path. The first optical system is telecentric on the magnification side. In a case in which there are a plurality of optical systems which include an optical element closest to the reduction side in the projection optical system and which are telecentric on the magnification side, among the plurality of optical systems, an optical system in which a number of included optical elements is smallest is the first optical system, the first optical system is a coaxial system having a common first optical axis and is non-telecentric on the reduction side, the second optical system is a coaxial system having a common second optical axis and is telecentric on the reduction side, and a relative position of the first optical axis and the second optical axis is variable.

In the present specification, it should be noted that the terms “consisting of ˜” and “consists of ˜” mean that the lens may include not only the above-mentioned elements but also lenses substantially having no powers, optical elements, which are not lenses, such as a stop, a filter, and a cover glass, and mechanism parts such as a lens flange, a lens barrel, an imaging element, and a camera shaking correction mechanism.

The sign of the power and the surface shape of the lens including the aspherical surface will be considered in terms of the paraxial region unless otherwise specified. The “focal length” used in each conditional expression is a paraxial focal length. Unless otherwise specified, the values used in Conditional Expression are values in a case where the d line is used as a reference in a state where the infinite distance object is in focus, and are values at the wide-angle end in a case where the projection optical system is a variable magnification optical system. The “d line”, “C line”, and “F line” described herein are bright lines, the wavelength of the d line is 587.56 nm (nanometers), the wavelength of the C line is 656.27 nm (nanometers), and the wavelength of the F line is 486.13 nm (nanometers).

According to the technique of the present disclosure, it is possible to provide a projection optical system, which is compact, has a lens shift function, and is able to form a favorable projection image, and a projection type display device comprising the projection optical system.

### BRIEF DESCRIPTION OF THE DRAWINGS

FIG. 1 is a conceptual diagram for explaining a configuration of a projection optical system according to an embodiment.

FIG. 2 is a conceptual diagram for explaining a configuration of a projection optical system according to another embodiment.

FIG. 3 is a conceptual diagram for explaining a configuration of a projection optical system according to still another embodiment.

FIG. 4 is a cross-sectional view showing a configuration and rays of a projection optical system of Example 1-1.

FIG. 5 is a cross-sectional view showing a configuration and rays of a projection optical system of Example 1-2.

FIG. 6 is a cross-sectional view showing a configuration and rays of a projection optical system of Modification Example 1-1.

FIG. 7 is a cross-sectional view showing a configuration and rays of a projection optical system of Modification Example 1-2.

FIG. 8 is a diagram of aberrations in the projection optical system of Example 1.

FIG. 9 is a cross-sectional view showing a configuration and rays of a projection optical system of Example 2-1.

FIG. 10 is a cross-sectional view showing a configuration and rays of a projection optical system of Example 2-2.

FIG. 11 is a cross-sectional view showing a configuration and rays of a projection optical system of Modification Example 2-1.

FIG. 12 is a cross-sectional view showing a configuration and rays of a projection optical system of Modification Example 2-2.

FIG. 13 is a diagram of aberrations in the projection optical system of Example 2.

FIG. 14 is a cross-sectional view showing a configuration and rays of a projection optical system of Example 3-1.

FIG. 15 is a cross-sectional view showing a configuration and rays of a projection optical system of Example 3-2.

FIG. 16 is a diagram of aberrations in the projection optical system of Example 3.

FIG. 17 is a cross-sectional view showing a configuration and rays of a projection optical system of Example 4-1.

FIG. 18 is a cross-sectional view showing a configuration and rays of a projection optical system of Example 4-2.

FIG. 19 is a diagram of aberrations in the projection optical system of Example 4.

FIG. 20 is a schematic configuration diagram of a projection type display device according to an embodiment.

FIG. 21 is a schematic configuration diagram of a conventional projection type display device as a reference example.

FIG. 22 is a schematic configuration diagram of another conventional projection type display device as a reference example.

### DESCRIPTION OF EMBODIMENTS

Hereinafter, embodiments of the present disclosure will be described in detail with reference to the accompanying drawings. The projection optical system according to the embodiment of the present disclosure is, for example, an optical system that is mounted on a projection type display device and projects an image, which is output by an image display element such as a digital micromirror device (DMD: registered trademark), onto a projection surface such as a screen.

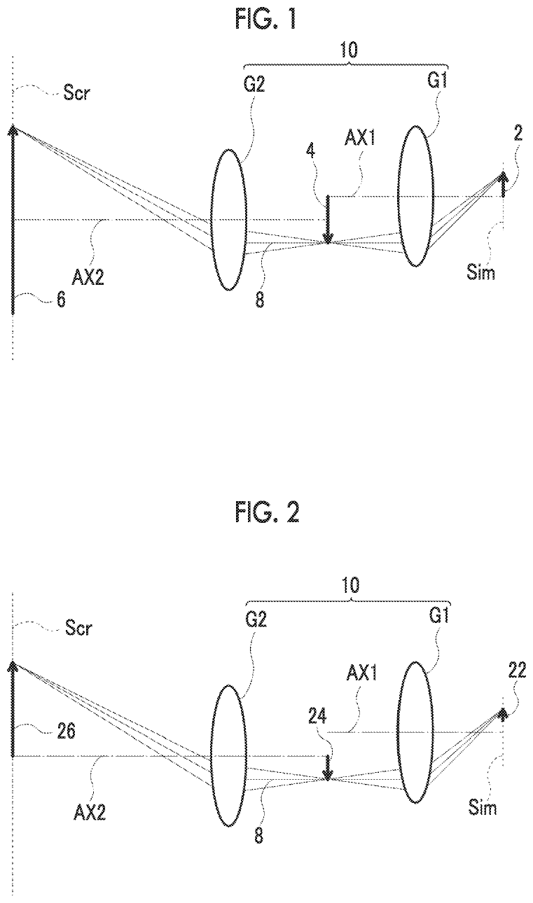

FIG. 1 shows a conceptual diagram for explaining a configuration of a projection optical system 10 according to the embodiment of the present disclosure. The projection optical system 10 of FIG. 1 forms an intermediate image 4 of an image 2 displayed on the image display surface Sim of the image display element, and forms a projection image 6 by projecting the intermediate image 4 onto the screen Scr. That is, the image 2, the intermediate image 4, and the projection image 6 are all optically conjugate. The projection image 6 corresponds to a magnified image in the technique of the present disclosure. In the description about FIG. 1, the “magnification side” means the screen Scr side, and the “reduction side” means the image display surface Sim side. In FIG. 1, the left side is the magnification side and the right side is the reduction side.

The projection optical system 10 consists of a first optical system G1 and a second optical system G2, in order from the reduction side to the magnification side along the optical path. Practically, the first optical system G1 mostly consists of a plurality of optical elements, and in the example described later. Thus, the first optical system G1 is configured to include a plurality of lenses. However, in order to facilitate understanding in FIG. 1, the first optical system G1 is conceptually illustrated. This point is the same for the second optical system G2.

The first optical system G1 is a coaxial system having a common first optical axis AX1. That is, all the optical elements in the first optical system G1 have the first optical axis AX1 as a common optical axis. The second optical system G2 is a coaxial system having a common second optical axis AX2. That is, all the optical elements in the second optical system G2 have the second optical axis AX2 as a common optical axis. In the following, the first optical axis AX1 and the second optical axis AX2 may be collectively referred to as an optical axis.

As shown in FIG. 1, the first optical axis AX1 and the second optical axis AX2 are parallel and are not on the same straight line. In other words, the first optical axis AX1 and the second optical axis AX2 are in a parallel-shifted relationship. It should be noted that the term “parallel” in the present specification includes not only perfect parallelism but also substantially parallelism including an error generally allowed in the technical field to which the technique of the present disclosure belongs. The allowable error is, for example, within a range in which the angle formed by the first optical axis AX1 and the second optical axis AX2 is −1 degree or more and +1 degree or less.

The first optical system G1 is non-telecentric on the reduction side. Since the first optical system G1 is the optical system located closest to the reduction side in the projection optical system 10, the projection optical system 10 is non-telecentric on the reduction side. By making the projection optical system 10 a non-telecentric optical system on the reduction side, it is easy to reduce the diameter of an optical element such as a lens in the projection optical system 10. Thus, there is an advantage in achieving reduction in size.

The first optical system G1 is telecentric on the magnification side. Further, the first optical system G1 is defined as an optical system in which the number of optical elements disposed closest to the reduction side in the projection optical system 10 and included in the optical systems telecentric on the magnification side is the smallest. That is, in a case where there are a plurality of optical systems which include an optical element closest to the reduction side in the projection optical system 10 and are telecentric on the magnification side, among the plurality of optical systems, the optical system in which the number of included optical elements is smallest is the first optical system G1. As a result, the boundary between the first optical system G1 and the second optical system G2 is determined.

Regarding the above definition, description will be given based on the following example. The projection optical system 10 consists of ten lenses including a lens L1, a lens L2, a lens L3, a lens L4, a lens L5, a lens L6, a lens L7, a lens L8, a lens L9, and a lens L10 in order from the reduction side to the magnification side along the optical path. In this example, the optical element closest to the reduction side is the lens L1. As optical systems that include the optical elements closest to the reduction side and are telecentric on the magnification side, the following three optical systems may be considered: an optical system A consisting of two lenses including a lens L1 and a lens L2; an optical system B consisting of four lenses including a lens L1, a lens L2, a lens L3, and a lens L4; and an optical system C consisting of seven lenses including a lens L1, a lens L2, a lens L3, a lens L4, a lens L5, a lens L6, and a lens L7. In such a case, there are three telecentric optical systems including the optical element closest to the reduction side and telecentric on the magnification side. Among these three optical systems, the optical system containing the smallest number of optical elements is an optical system A consisting of two lenses. Therefore, in such a case, the optical system A is the first optical system G1, and the gap between the lens L2 and the lens L3 is the boundary between the first optical system G1 and the second optical system G2.

As shown in FIG. 1, “the first optical system G1 is telecentric on the magnification side” means a state in which the principal ray 8 emitted from the first optical system G1 to the magnification side is parallel to the optical axis. As described above, the term “parallel” in the present specification includes not only perfect parallelism but also substantially parallelism including an allowable error. The allowable error is in the range where the inclination of the principal ray 8 with respect to the optical axis is −3 degrees or more and +3 degrees or less. The term “non-telecentric” refers to a state in which the inclination of the principal ray 8 with respect to the optical axis is outside the range of −3 degrees or more and +3 degrees or less. In an optical system in which the principal ray is not determined, the angle bisector of the maximum ray on the upper side and the maximum ray on the lower side of the rays may be used as a substitute for the principal ray.

Since the first optical system G1 is telecentric on the magnification side, the second optical system G2 is telecentric on the reduction side. Here, similarly to the phrase “the first optical system G1 is telecentric on the magnification side”, the phrase “the second optical system G2 is telecentric on the reduction side” refers to a state in which the inclination of the lens with respect to the optical axis of the principal ray 8 incident on the second optical system G2 from the reduction side is within the range of −3 degrees or more and +3 degrees or less.

The above telecentric configuration is extremely effective in a case where the projection optical system 10 is shifted in the direction perpendicular to the optical axis with respect to the image display element. Hereinafter, shifting the projection optical system 10 with respect to the image display element in a direction perpendicular to the optical axis is referred to as “lens shift” for convenience. In a configuration in which the first optical system G1 is non-telecentric on the magnification side and the second optical system G2 is non-telecentric on the reduction side, in a case where the lens is shifted, a part of the rays for imaging is blocked, so-called vignetting may occur. In a state where vignetting occurs, a part of the projection image 6 is missing and a favorable projection image 6 cannot be obtained. Therefore, it cannot be said that the lens shift function is substantially provided. On the other hand, in the projection optical system 10, the first optical system G1 is telecentric on the magnification side, and the second optical system G2 is telecentric on the reduction side. Therefore, vignetting does not occur even in a case where the lens is shifted, and a favorable projection image 6 without image missing can be obtained.

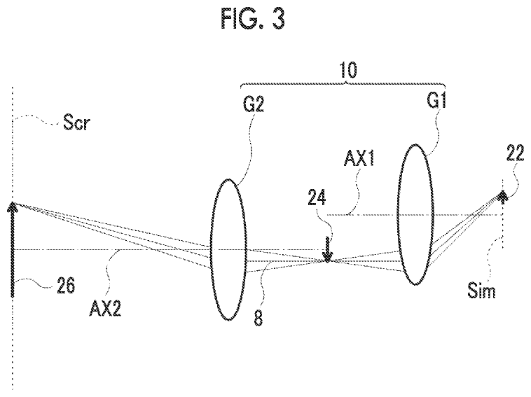

Further, in the projection optical system 10, since the first optical axis AX1 and the second optical axis AX2 are shifted in parallel, it is possible to form the projection image 6 in the region including the second optical axis AX2. This point will be described with reference to FIGS. 2 and 3. In the example of FIG. 2, only an image 22 is different from the example of FIG. 1 while keeping the configuration of the projection optical system 10 the same. The image 22 of FIG. 2 is obtained by leaving only the upper half of image 2 of FIG. 1 and deleting the lower half. In the projection optical system 10 non-telecentric on the reduction side, in most cases, it is difficult for an image to be disposed near the optical axis in the image circle on the reduction side due to the configuration of the illumination system disposed between the light source and the image display element. In FIG. 2, in consideration of this situation, the image 22 is located in a region away from the first optical axis AX1.

Unlike the projection optical system 10, in a conventional projection optical system which is non-telecentric on the reduction side and in which the first optical axis AX1 and the second optical axis AX2 are on the same straight line, in a case where the projection image of the image at a position away from the optical axis is formed, the projection image can also be formed only at a position away from the optical axis. That is, the conventional projection optical system as described above is unable to obtain a projection image in a region including the optical axis.

On the other hand, in the projection optical system 10 shown in FIG. 2, since the first optical axis AX1 and the second optical axis AX2 are shifted in parallel, it is possible to perform projection such that the lower end of the projection image 26 is located on the second optical axis AX2.

In the example of FIG. 3, the amount of deviation between the first optical axis AX1 and the second optical axis AX2 is larger than that of the example of FIG. 2 while keeping the size of the image 22 and the position thereof with respect to the first optical axis AX1 the same. In the example of FIG. 3, the center of the projection image 26 is located on the second optical axis AX2.

As can be seen from FIGS. 2 and 3, the projection image 26 can be formed in the region including the second optical axis AX2 in the projection optical system 10. Further, in the projection optical system 10, it is possible to adjust the location of the projection image 26 on the screen Scr by changing the amount of deviation between the first optical axis AX1 and the second optical axis AX2 while keeping the relative positions of the image display element and the first optical system G1 fixed. Compared to the configuration in which the entire projection optical system is shifted with respect to the image display element to adjust the location of the projection image 26, in the projection optical system 10, only a part of the optical system may be shifted. Therefore, it is possible to achieve reduction in size of the device.

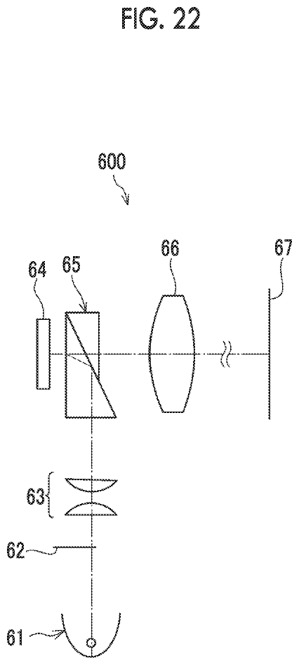

As a reference example, FIGS. 21 and 22 each show a schematic configuration diagram of a projection type display device including a conventional projection optical system. Both the projection type display devices shown in FIGS. 21 and 22 are of a type using a single plate DMD. The projection type display device 500 shown in FIG. 21 comprises a light source 51, a color wheel 52, a light guide optical system 53, a DMD 54, and a projection lens 55. The projection lens 55 projects a magnified image of the image displayed by the DMD 54 onto the screen 56. The projection lens 55 is an optical system which is non-telecentric on the reduction side. Thus, there is an advantage in reducing the lens diameter on the reduction side. However, in the projection type display device 500, vignetting occurs in a case where the lens is shifted. Further, the projection type display device 500 is unable to form a projection image in a region including the optical axis of the projection lens 55.

The projection type display device 600 shown in FIG. 22 comprises a light source 61, a color wheel 62, a light guide optical system 63, a total internal reflection (TIR) prism 64, a DMD 65, and a projection lens 66. The projection lens 66 projects a magnified image of the image displayed by the DMD 65 onto the screen 67. The projection lens 66 can be configured such that vignetting does not occur even in a case where the lens is shifted and a projection image is formed in a region including an optical axis. However, the projection lens 66 used in combination with the TIR prism 64 is disadvantageous in reduction in size because the lens diameter on the reduction side is large. Further, the projection type display device 600 includes the TIR prism 64, which makes the device larger.

Compared with the conventional examples of FIGS. 21 and 22, the projection optical system 10 according to the embodiment of the present disclosure does not include a TIR prism. Thus, there is an advantage in achieving reduction in size. Further, the projection optical system 10 does not cause vignetting even in a case where the lens is shifted, and is able to form a projection image in a region including an optical axis.

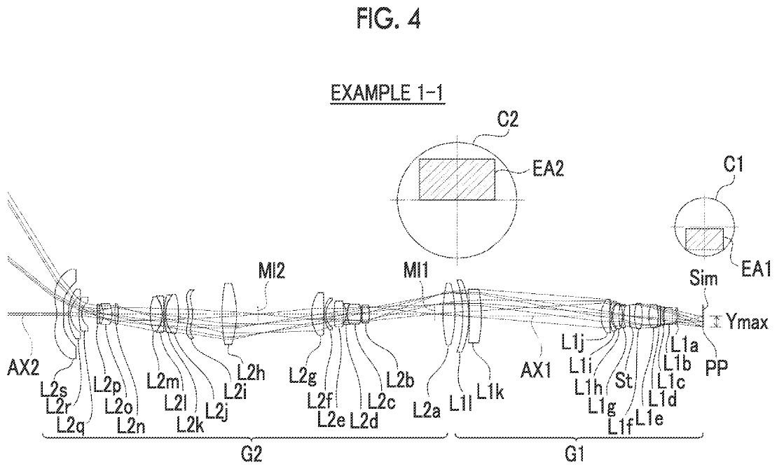

Next, a specific configuration example of the projection optical system according to the embodiment of the present disclosure will be described. FIG. 4 shows a cross-sectional view of a specific configuration example of the projection optical system according to the embodiment of the present disclosure. The example shown in FIG. 4 corresponds to Example 1-1 described later. FIG. 4 also shows the rays and the image display surface Sim of the image display element, where the left side is the magnification side and the right side is the reduction side. FIG. 4 shows, as the rays, rays having the minimum image height, rays having the intermediate image height, and rays having the maximum image height.

The projection optical system of FIG. 4 consists of a first optical system G1 and a second optical system G2, in order from the reduction side to the magnification side. The first optical system G1 consists of lenses L1a to L1f, an aperture stop St, and lenses L1g to L1l, in order from the reduction side to the magnification side. The second optical system G2 consists of lenses L2a to L2s in order from the reduction side to the magnification side.

FIG. 4 shows an example in which an optical member PP is disposed on the reduction side in the projection optical system, under the assumption that the projection optical system is mounted on a projection type display device. The optical member PP is a member assumed to include at various filters, a cover glass, and/or the like. The optical member PP has no refractive power, and the optical member PP may be configured to be omitted.

The projection optical system of FIG. 4 forms two intermediate images inside the projection optical system. The first intermediate image MI1 is formed between the lens L2a and the lens L2b. The second intermediate image MI2 is formed between the lens L2g and the lens L2h. In FIG. 4, the first intermediate image MI1 and the second intermediate image MI2 are shown only in the vicinity of the optical axis. The first optical system G1 is a coaxial system, and all the lenses of the first optical system G1 have the first optical axis AX1 in common. The second optical system G2 is a coaxial system, and all the lenses of the second optical system G2 have a second optical axis AX2 in common. The first optical axis AX1 and the second optical axis AX2 are parallel. A line connecting the first optical axis AX1 and the second optical axis AX2 is drawn at the boundary between the first optical system G1 and the second optical system G2 in FIG. 4. However, the connection line is virtual and does not indicate the exact configuration.

The circle drawn above the image display surface Sim in FIG. 4 indicates the image circle C1 on the reduction side in the first optical system G1. The center of the image circle C1 is on the first optical axis AX1. The rectangular shaded portion in the image circle C1 in FIG. 4 indicates the usable area EA1 with respect to the image circle C1. The usable area EA1 is an area of an image displayed on the image display surface Sim. The usable area EA1 is located below the center of the image circle C1 and away from the center. That is, the usable area EA1 is located below the first optical axis AX1.

The circle drawn above the lens L2a in FIG. 4 indicates the image circle C2 on the reduction side in the second optical system G2. The center of the image circle C2 is on the second optical axis AX2. The rectangular shaded portion in the image circle C2 in FIG. 4 indicates the usable area EA2 with respect to the image circle C2. The usable area EA2 is a region of effective rays used for forming a projection image. The usable area EA2 is located in the upper half of the image circle C2. The lower end of the usable area EA2 is located on the second optical axis AX2. That is, similarly to the conceptual diagram of FIG. 2, in the example shown in FIG. 4, the image 2 is not located on the first optical axis AX1, but the projection image is located on the second optical axis AX2.

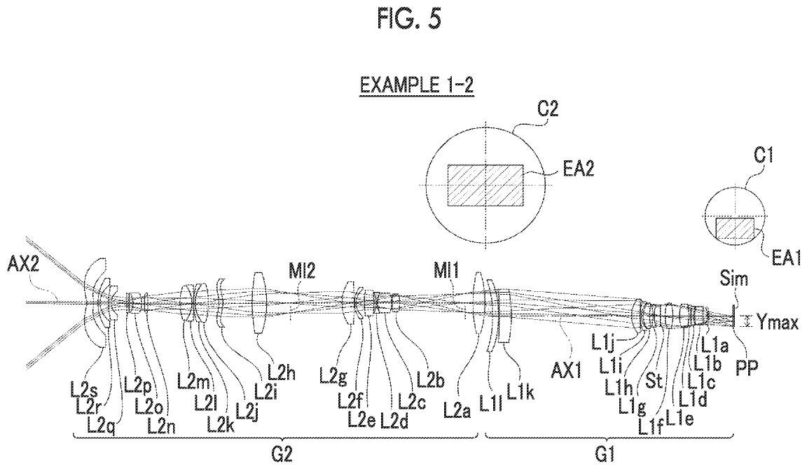

FIG. 5 shows a configuration example in which the amount of deviation between the first optical axis AX1 and the second optical axis AX2 is increased from the example of FIG. 4. The example shown in FIG. 5 corresponds to Example 1-2 described later. The basic illustration method of FIG. 5 is the same as that of FIG. 4.

The position of the usable area EA1 in the image circle C1 of the example of FIG. 5 is the same as that of the example of FIG. 4. However, the center of the usable area EA2 in the example of FIG. 5 coincides with the center of the image circle C2. That is, similarly to the conceptual diagram of FIG. 3, in the example shown in FIG. 5, the image is not located on the first optical axis AX1, but the center of the projection image is located on the second optical axis AX2.

As shown in the examples of FIGS. 4 and 5, in the projection optical system according to the embodiment of the present disclosure, even in a case where the image displayed on the image display surface Sim is disposed in a region not including the first optical axis AX1, it is possible to form a projection image in the region including the second optical axis AX2.

The projection optical system according to the embodiment of the present disclosure can be modified in terms of various elements including the amount of deviation between the first optical axis AX1 and the second optical axis AX2. For example, in the examples of FIGS. 4 and 5, the first intermediate image MI1 and the second intermediate image MI2 are formed inside the second optical system G2. However, one of the intermediate images may be formed between the first optical system G1 and the second optical system G2. In a case where an intermediate image is formed between the first optical system G1 and the second optical system G2, the performance can be confirmed only by the first optical system G1 or the second optical system G2. As a result, there is an advantage in manufacturing. Further, in a case where an intermediate image can be formed between the first optical system G1 and the second optical system G2 and at an air gap away from the lens, there are scratches on the lens surface and/or impurities inside the lens. In this case, it is possible to suppress reflection in the projection image and deterioration in the image quality.

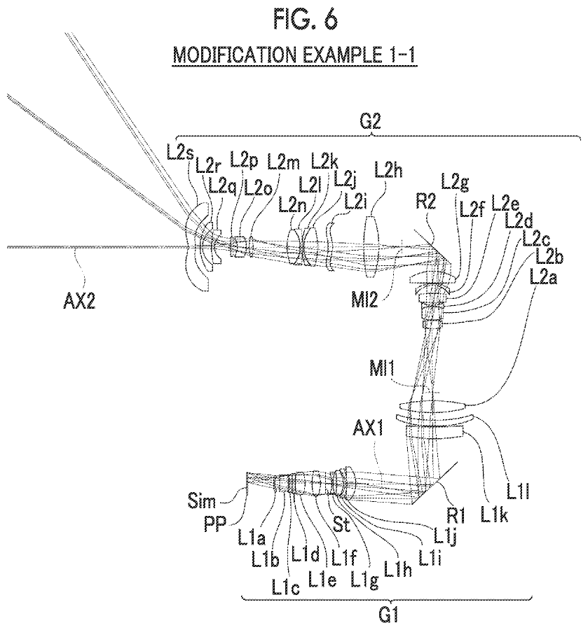

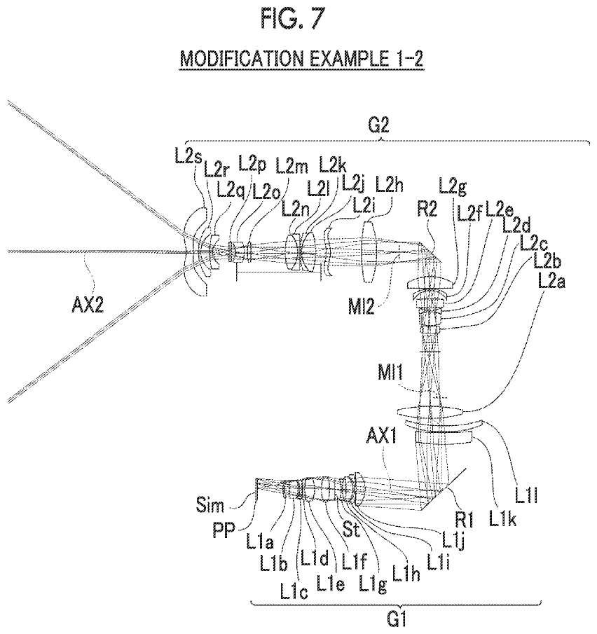

Further, although the projection optical systems of FIGS. 4 and 5 each have a linear optical path, each projection optical system may have a bent optical path. By providing the bent optical path, a configuration advantageous for reduction in size can be obtained. FIGS. 6 and 7 show examples of a projection optical system having a bent optical path as Modification Example 1-1 and Modification Example 1-2, respectively. In the example of FIG. 6, as compared with the example of FIG. 4, a mirror R1 is added between the lens L1j and the lens L1k, and a mirror R2 is added between the lens L2g and the lens L2h, thereby constituting a bent optical path which is an optical path deflected twice. In the example of FIG. 7, the mirror R1 is added between the lens L1j and the lens L1k, and the mirror R2 is added between the lens L2g and the lens L2h with respect to the example of FIG. 5, thereby constituting a bent optical path which is an optical path deflected twice.

The mirrors R1 and R2 in the examples of FIGS. 6 and 7 deflect the optical path by 90 degrees, but the angle at which the optical path is deflected is not limited thereto. The angle at which the optical path is deflected is not limited to exactly 90 degrees, and may be, for example, an angle including an error in the range of −3 degrees or more and +3 degrees or less. It is preferable that the angle of deflection is 90 degrees since the structure is simple in terms of assembling and manufacturing, but the angle is not necessarily 90 degrees.

Further, the number and the directions of deflections of the optical path are not limited to the examples of FIGS. 6 and 7. In a case where there is a location suitable that deflects the optical path, the number of deflections of the optical path can be optionally set in accordance with the number of the locations. In a case where the number of deflections of the optical path is two, the directions of both deflections of the optical path may be the same, or the directions of the first deflection and the second deflection of the optical path may be opposite to each other. Further, unlike the examples shown in FIGS. 6 and 7, the optical path may be deflected in the direction perpendicular to the paper surface. The deflecting direction can be set optionally, but it is preferable to set the direction appropriately in consideration of the usable area of the image circle.

The “magnification side” and “reduction side” according to the technique of the present disclosure are determined depending on the optical path, and the same applies to a projection optical system that has a bent optical path. For example, in the projection optical system that has a bent optical path, the phrase “the lens LA is closer to the magnification side than the lens LB” has the same meaning as the phrase “the lens LA is on the optical path to be closer to the magnification side than the lens LB”. Therefore, the term “˜ closest to the magnification side” in the projection optical system that has the bent optical path means that something is closest to the magnification side on the optical path in terms of arrangement order, and does not mean that the something is closest to the screen Scr in terms of distance.

Next, a preferred configuration of the projection optical system according to the embodiment of the present disclosure will be described. Assuming that the distance on the first optical axis AX1 from the reduction side focal position of the projection optical system as a base point to the reduction side pupil position of the projection optical system is Exp and the maximum image height of the projection optical system on the reduction side is Y max, it is preferable that the projection optical system satisfies Conditional Expression (1). Here, a sign of the distance of Exp on the magnification side from the base point is negative and a sign of the distance of Exp on the reduction side from the base point is positive. The reduction side pupil position corresponds to the exit pupil position in a case where the magnification side and the reduction side in the projection optical system are respectively regarded as the object side and the image side and light is incident onto the projection optical system from the object side. Y max corresponds to the radius of the image circle (so-called maximum effective image circle) on the reduction side in the projection optical system. Further, in the present specification, Y max is set as a positive value. By not allowing the result of Conditional Expression (1) to be equal to or less than the lower limit, there is an advantage in achieving reduction in size of the optical element on the reduction side in the first optical system G1. By not allowing the result of Conditional Expression (1) to be equal to or greater than the upper limit, it is easy to correct various aberrations such as field curvature and astigmatism. In order to obtain more favorable characteristics, it is more preferable that the projection optical system satisfies Conditional Expression (1-1).

−5<Exp/Y max<−0.5 (1)

−4<Exp/Y max<−1 (1-1)

Assuming that an air conversion distance on the first optical axis AX1 from a surface closest to the reduction side in the first optical system G1 as a base point to a reduction side focal position of the first optical system G1 is Bf1, an air conversion distance on the first optical axis AX1 from a surface closest to the reduction side in the projection optical system as a base point to a reduction side focal position of the projection optical system is Bf, and a distance on the first optical axis AX1 from the reduction side focal position of the projection optical system as a base point to a reduction side pupil position of the projection optical system is Exp, it is preferable that the projection optical system satisfies Conditional Expression (2). Here, a sign of each distance of Bf1, Bf, and Exp on the magnification side from each base point is negative and a sign of the distance of Bf1, Bf, and Exp on the reduction side from each base point is positive. By satisfying Conditional Expression (2), it is possible to configure the second optical system G2 such that vignetting does not occur even in a case where the second optical system G2 is shifted in the direction perpendicular to the second optical axis AX2 with respect to the image display element. In order to obtain more favorable characteristics, it is more preferable that the projection optical system satisfies Conditional Expression (2-1). By not allowing the result of Conditional Expression (2-1) to be equal to or less than the lower limit, the spread of the rays from the image display surface Sim toward the first optical system G1 can be suppressed. Thus, there is an advantage in achieving reduction in size of the entire projection optical system.

−1.5<(Bf1−Bf−Exp)/Y max<1.5 (2)

0<(Bf1−Bf−Exp)/Y max<1 (2-1)

Assuming that a maximum image height on the reduction side of the projection optical system is Y max, a focal length of the second optical system G2 is f2, a focal length of the projection optical system is f, a distance in a direction of the second optical axis AX2 to a sagittal image plane at an image height of Y max×|f2/f|×0.8 on the reduction side in the second optical system G2 in a case where a paraxial imaging position on the reduction side in the second optical system G2 is set as a base point in a state where the magnified image is located at infinity is Sr, and a distance in the direction of the second optical axis AX2 to the tangential image plane at the image height of Y max×|f2/f|×0.8 on the reduction side in the second optical system G2 in a case where the paraxial imaging position on the reduction side in the second optical system G2 is set as the base point in a state where the magnified image is located at infinity is Tr, it is preferable that the projection optical system satisfies Conditional Expressions (3) and (4). Here, a sign of each distance of Sr and Tr on the magnification side from each base point is negative and a sign of the distance of Sr and Tr on the reduction side from each base point is positive. Further, each value of f2 and f is set at a wide-angle end in a case where each optical system is a variable magnification optical system. A wide angle of view can be ensured by satisfying Conditional Expression (3). |{(Sr+Tr)/2}/Y max| is an absolute value, and is thus 0<|{(Sr+Tr)/2}/Y max|. Conditional Expression (4) is an expression relating to field curvature. By not allowing the result of Conditional Expression (4) to be equal to or greater than the upper limit, it is easy to maintain a state in which the field curvature is satisfactorily corrected in a configuration in which the first optical axis AX1 and the second optical axis AX2 are parallel to each other. By satisfying Conditional Expressions (3) and (4), there is an advantage in realizing a wide-angle optical system in which the field curvature is satisfactorily corrected. In order to obtain more favorable characteristics, it is more preferable that the projection optical system satisfies Conditional Expressions (3) and (4) and then satisfies at least one of Conditional Expressions (3-1), (3-2), (3-3), or (4-1). By not allowing the result of Conditional Expression (3-3) to be equal to or greater than the upper limit, it is easy to perform aberration correction while suppressing an increase in the diameter of the optical element of the second optical system G2.

0.47<Y max/|f| (3)

0.84<Y max/|f| (3-1)

1.2<Y max/|f| (3-2)

1.73<Y max/|f|<5 (3-3)

0<|(Sr+Tr)/2|/Y max<0.1 (4)

0<|(Sr+Tr)/2|/Y max<0.05 (4-1)

Assuming that a focal length of the second optical system G2 is f2 and a focal length of the projection optical system is f, it is preferable that the projection optical system satisfies Conditional Expression (5). Here, each value of f2 and f is set at a wide-angle end in a case where each optical system is a variable magnification optical system. By not allowing the result of Conditional Expression (5) to be equal to or less than the lower limit, there is an advantage in correcting the aberration of the second optical system G2. By not allowing the result of Conditional Expression (5) to be equal to or greater than the upper limit, there is an advantage in suppressing an increase in size of the optical system. In order to obtain more favorable characteristics, it is more preferable that the projection optical system satisfies Conditional Expression (5-1).

0.6<|f2/f|<4 (5)

1<|f2/f|<3 (5-1)

Assuming that an air conversion distance on the second optical axis AX2 from a surface closest to the reduction side in the second optical system G2 as a base point to a reduction side focal position of the second optical system G2 is Bf2, and a focal length of the projection optical system is f, it is preferable that the projection optical system satisfies Conditional Expression (6). Here, a sign of the distance of Bf2 on the magnification side from the base point is negative and a sign of the distance of Bf2 on the reduction side from the base point is positive. Further, a value of f is set at a wide-angle end in a case where the projection optical system is a variable magnification optical system. By not allowing the result of Conditional Expression (6) to be equal to or less than the lower limit, the distance between the optical element closest to the reduction side in the second optical system G2 and the intermediate image is prevented from becoming excessively large. As a result, there is an advantage in reducing the diameter of the optical element closest to the reduction side in the second optical system G2. By not allowing the result of Conditional Expression (6) to be equal to or greater than the upper limit, the back focal length of the second optical system G2 is prevented from becoming excessively long. As a result, there is an advantage in suppressing an increase in size of the optical system. In order to obtain more favorable characteristics, it is more preferable that the projection optical system satisfies Conditional Expression (6-1).

−5<Bf2/|f|<5 (6)

−3<Bf2/|f|<3 (6-1)

Assuming that an air conversion distance on the first optical axis AX1 from a surface closest to the reduction side in the projection optical system as a base point to a reduction side focal position of the projection optical system is Bf and a focal length of the projection optical system is f, it is preferable that the projection optical system satisfies Conditional Expression (7). Here, a sign of the distance of Bf on the magnification side from the base point is negative and a sign of the distance of Bf on the reduction side from the base point is positive. Further, a value of f is set at a wide-angle end in a case where the projection optical system is a variable magnification optical system. By not allowing the result of Conditional Expression (7) to be equal to or less than the lower limit, there is an advantage in avoiding interference with the illumination system member. By not allowing the result of Conditional Expression (7) to be equal to or greater than the upper limit, the back focal length of the projection optical system is prevented from becoming excessively long. As a result, there is an advantage in suppressing an increase in size of the optical system. In order to obtain more favorable characteristics, it is more preferable that the projection optical system satisfies Conditional Expression (7-1).

0.5<Bf/|f|<10 (7)

0.8<Bf/|f|<5 (7-1)

Further, the projection optical system may be configured as follows, for example. The second optical system G2 may comprise a negative meniscus lens closest to the magnification side. In such a case, there is an advantage in increasing the angle of view. The second optical system G2 may comprise a plurality of negative meniscus lenses successively in order from the most magnification side. In such a case, there is an advantage in increasing the angle of view. The lens closest to the reduction side in the second optical system G2 may be a positive lens. In such a case, there is an advantage in reducing the diameter of the lens and ensuring telecentricity. The lens closest to the magnification side in the first optical system G1 may be a positive lens. In such a case, there is an advantage in reducing the diameter of the lens. The lens surface closest to the magnification side in the first optical system G1 may be a concave surface. In such a case, there is an advantage in ensuring telecentricity.

The number of lenses included in the first optical system G1 and the second optical system G2 may be different from the number in the example shown in FIG. 4. All the optical elements having power included in the projection optical system may be configured to be lenses, or the optical elements having power may be configured to include a reflective member having a curvature. All lenses included in the projection optical system preferably have a refractive index of 2.2 or less at the d line, and more preferably 2 or less in consideration of the availability of current lens materials. The projection optical system may be configured to include a diffractive optical surface. The projection optical system preferably has an F number of 3 or less. In the projection optical system, it is preferable that distortion is suppressed within a range of −3% or more and +3% or less.

The above-mentioned preferred configurations and available configurations including the configurations relating to Conditional Expressions may be any combination, and it is preferable to appropriately selectively adopt the configurations in accordance with required specification. It should be noted that the ranges of the possible conditional expressions are not limited to Conditional Expressions described in the form of the expression, and the lower limit and the upper limit are selected from each of the preferable and more preferable conditional expressions. The ranges of Conditional Expressions include ranges obtained through optional combinations.

Next, examples of the projection optical system according to the technique of the present disclosure and modification examples thereof will be described.

The projection optical systems of Examples 1-1 and 1-2 each have a linear optical path. The lens configuration and rays of the projection optical system of Example 1-1 are shown in FIG. 4. Since the configuration shown in FIG. 4 is described above, description will not be repeated here.

The lens configuration and rays of the projection optical system of Example 1-2 are shown in FIG. 5. Each lens of Example 1-2 is the same as each lens of Example 1-1. The projection optical system of Example 1-2 is an optical system in which the amount of deviation between the first optical axis AX1 and the second optical axis AX2 is increased from the projection optical system of Example 1-1. Since the configuration shown in FIG. 5 is described above, description will not be repeated here.

The projection optical systems of Modification Examples 1-1 and Modification Examples 1-2 each have a bent optical path. The lens configuration and rays of the projection optical system of Modification Example 1-1 are shown in FIG. 6. The lens configuration and rays of the projection optical system of Modification Example 1-2 are shown in FIG. 7. Since the configurations shown in FIGS. 6 and 7 have been described above, description will not be repeated here.

Next, the numerical data will be described. Hereinafter, for convenience of explanation, a projection optical system in which the first optical axis AX1 and the second optical axis AX2 of Example 1-1 are aligned on the same straight line is shown as the “projection optical system of Example 1”. The projection optical system of Example 1 is also a projection optical system in which the first optical axis AX1 and the second optical axis AX2 of Example 1-2 are aligned on the same straight line.

Regarding the projection optical system of Example 1, Tables 1A and 1B show basic lens data, Table 2 shows specification, and Table 3 shows the aspherical coefficients thereof. Here, the basic lens data is divided into two tables, Table 1A and Table 1B, to avoid lengthening of one table. Table 1A shows the second optical system G2, and Table 1B shows the first optical system G1 and the optical member PP.

In Tables 1A and 1B, the column of Sn shows surface numbers. The surface closest to the magnification side is the first surface, and the surface numbers increase one by one toward the reduction side. The column of R shows radii of curvature of the respective surfaces. The column of D shows surface distances on the optical axis between the respective surfaces and the surfaces adjacent to the reduction side. Further, the column of Nd shows refractive indices of the constituent elements at the d line, and the column of νd shows Abbe numbers of the constituent elements based on the d line.

In Tables 1A and 1B, signs of radii of curvature of surface shapes convex toward the magnification side are set to be positive, and signs of radii of curvature of surface shapes convex toward the reduction side are set to be negative. In Table 1B, in a place of a surface number of a surface corresponding to the aperture stop St, the surface number and a term of (St) are noted. A value at the bottom place of D in Table 1B indicates a distance between the image display surface Sim and the surface closest to the reduction side in the table.

Table 2 shows the absolute value of the focal length |f|, the F number FNo., the maximum total angle of view 2ω, and a value of the maximum image height Y max, on a d line basis. (°) in the place of 2ω indicates that the unit thereof is a degree.

In the basic lens data, the reference sign * is attached to surface numbers of aspherical surfaces, and numerical values of the paraxial radius of curvature are written into the column of the radius of curvature of the aspherical surface. In Table 3, the row of Sn shows surface numbers of the aspherical surfaces, and the rows of KA and Am shows numerical values of the aspherical coefficients for each aspherical surface. m is an integer of 3 or more and varies depending on the surface. For example, on the first surface, m=3, 4, 5, . . . , 20. The “E±n” (n: an integer) in numerical values of the aspherical coefficients of Table 3 indicates “×10^{±n}”. KA and Am are the aspherical coefficients in the aspherical surface expression represented by the following expression.

Zd=C×H²/{1+(1−KA×C²×H²)^{1/2}}+ΣAm×H^{m}

Here, Zd is an aspherical surface depth (a length of a perpendicular from a point on an aspherical surface at height H to a plane that is perpendicular to the optical axis and contacts with the vertex of the aspherical surface), H is a height (a distance from the optical axis to the lens surface), C is a paraxial curvature, and KA and Am are aspherical coefficients, and Σ in the aspherical surface expression means the sum with respect to m.

In data of each table, a degree is used as a unit of an angle, and mm (millimeter) is used as a unit of a length, but appropriate different units may be used since the optical system can be used even in a case where the system is enlarged or reduced in proportion. Further, each of the following tables shows numerical values rounded off to predetermined decimal places.

TABLE 1A

| Sn | R | D | Nd | vd |
|---|---|---|---|---|
| *1 | −15.5269 | 5.6000 | 1.53158 | 55.08 |
| *2 | −31.0112 | 3.8355 | | |
| 3 | 37.3668 | 1.8000 | 1.65160 | 58.55 |
| 4 | 18.3974 | 7.0861 | | |
| 5 | 65.9140 | 2.2500 | 1.85025 | 30.05 |
| 6 | 12.7265 | 12.8393 | | |
| 7 | −158.4030 | 1.8004 | 1.84666 | 23.78 |
| 8 | 371.1693 | 3.2543 | | |
| 9 | −15.8241 | 7.1613 | 1.72916 | 54.68 |
| 10 | −20.5103 | 2.3035 | | |
| 11 | 50.3701 | 2.8613 | 1.80518 | 25.46 |
| 12 | −68.3600 | 26.6692 | | |
| 13 | 43.2960 | 9.9104 | 1.49700 | 81.54 |
| 14 | −23.9341 | 1.3000 | 1.84666 | 23.78 |
| 15 | −1010.2946 | 0.1004 | | |
| 16 | 51.7456 | 1.2500 | 1.84666 | 23.78 |
| 17 | 24.9496 | 10.9670 | 1.49700 | 81.54 |
| 18 | −59.2102 | 8.2449 | | |
| *19 | −32.7382 | 3.4000 | 1.51007 | 56.24 |
| *20 | −26.9748 | 24.3293 | | |
| 21 | 136.1933 | 11.9990 | 1.84666 | 23.78 |
| 22 | −81.3325 | 62.4588 | | |
| 23 | 32.2627 | 10.0003 | 1.80400 | 46.53 |
| 24 | −564.3260 | 0.4004 | | |
| 25 | 22.2469 | 1.3854 | 1.84666 | 23.78 |
| 26 | 14.7027 | 6.8670 | | |
| 27 | 78.8269 | 7.8078 | 1.80518 | 25.46 |
| 28 | −84.9630 | 2.1060 | | |
| 29 | −18.4142 | 1.0100 | 1.59551 | 39.24 |
| 30 | 20.4730 | 11.5075 | 1.49700 | 81.54 |
| 31 | −25.3068 | 0.6002 | | |
| 32 | 96.0774 | 6.3464 | 1.49700 | 81.54 |
| 33 | −27.4504 | 60.5759 | | |
| 34 | 110.2270 | 10.0000 | 1.72916 | 54.68 |
| 35 | −90.9017 | 6.3762 | | |

TABLE 1B

| Sn | R | D | Nd | vd |
|---|---|---|---|---|
| *36 | −119.2955 | 5.0000 | 1.53158 | 55.08 |
| *37 | −98.9047 | 0.5000 | | |
| 38 | −387.6852 | 10.0000 | 1.84666 | 23.78 |
| 39 | −117.4499 | 99.3855 | | |
| 40 | 23.3278 | 7.0378 | 1.69350 | 53.20 |
| 41 | 117.5795 | 0.1010 | | |
| 42 | 39.2104 | 1.0010 | 1.63930 | 44.87 |
| 43 | 14.9479 | 1.4878 | | |
| 44 | 18.3976 | 5.3678 | 1.62041 | 60.29 |
| 45 | 56.2901 | 2.8343 | | |
| 46 | −32.6703 | 0.9999 | 1.67270 | 32.10 |
| 47 | 28.7462 | 4.9366 | | |
| 48(St) | ∞ | 4.0000 | | |
| 49 | 31.6271 | 6.5511 | 1.49700 | 81.54 |
| 50 | −36.5073 | 5.4018 | | |
| 51 | 27.6398 | 7.7218 | 1.77250 | 49.60 |
| 52 | −44.6958 | 0.1010 | | |
| 53 | −41.0493 | 1.6631 | 1.56732 | 42.82 |
| 54 | 191.3876 | 0.2920 | | |
| 55 | 1724.0944 | 1.7768 | 1.67270 | 32.10 |
| 56 | 19.5262 | 1.0583 | | |
| 57 | 29.3698 | 6.9779 | 1.84666 | 23.78 |
| 58 | 169.3627 | 3.7548 | | |
| 59 | −14.8108 | 1.0008 | 1.51742 | 52.43 |
| 60 | −32.0855 | 20.0002 | | |
| 61 | ∞ | 1.0500 | 1.51633 | 64.14 |
| 62 | ∞ | 0.0386 | | |

TABLE 2

| | |
|---|---|
| \|f\| | 5.02 |
| FNo. | 2.41 |
| 2ω(°) | 131.6 |
| Ymax | 23 |

TABLE 3

| Sn | 1 | 2 | 19 |
|---|---|---|---|
| KA | −1.154815336699E−03 | −9.180437119307E−01 | −3.357503618750E−01 |
| A3 | 1.124341500502E−03 | 1.376755775903E−03 | 0.000000000000E+00 |
| A4 | 1.443560692469E−04 | −2.910749750802E−05 | 2.657849997995E−05 |
| A5 | −9.607064931058E−06 | 1.366320013901E−05 | 4.827000334337E−07 |
| A6 | −9.796862356464E−08 | −1.164152391143E−06 | −4.062357540739E−07 |
| A7 | 2.237074550813E−08 | −1.510190182863E−08 | 3.244639342734E−08 |
| A8 | −2.062108174858E−11 | 5.096797753692E−09 | 2.371263111964E−09 |
| A9 | −4.254393622256E−11 | −9.108529562430E−11 | −2.017576250816E−10 |
| A10 | 4.030939261357E−13 | −1.032430627094E−11 | −5.881373910082E−12 |
| A11 | 5.769151708951E−14 | 3.725396325150E−13 | 5.322916255086E−13 |
| A12 | −9.541840832817E−16 | 9.071176049160E−15 | 7.889569948050E−15 |
| A13 | −4.938390566870E−17 | −5.447935050345E−16 | −7.425967902694E−16 |
| A14 | 1.091207415006E−18 | −1.957134931472E−18 | −5.948206724756E−18 |
| A15 | 2.475847670517E−20 | 3.924143379648E−19 | 5.713262093423E−19 |
| A16 | −6.652575351189E−22 | −2.134481052057E−21 | 2.439039542682E−21 |
| A17 | −6.575691328699E−24 | −1.403117620793E−22 | −2.290371520196E−22 |
| A18 | 2.083990700322E−25 | 1.468566369966E−24 | −4.835437314933E−25 |
| A19 | 7.066160184715E−28 | 1.989620258653E−26 | 3.737984631833E−26 |
| A20 | −2.645238834715E−29 | −2.721798485305E−28 | 3.303914281762E−29 |
| Sn | 20 | 36 | 37 |
| KA | −3.697490271497E+00 | −1.228654870400E+00 | 7.427465330000E−01 |
| A3 | 0.000000000000E+00 | 0.000000000000E+00 | 0.000000000000E+00 |
| A4 | 7.790145972096E−06 | −8.615553865943E−06 | −1.229448844607E−06 |
| A5 | 1.909407593422E−06 | 1.608540306944E−06 | −1.670718844252E−08 |
| A6 | −4.658728270573E−07 | −1.534513052763E−07 | 1.556208771734E−11 |
| A7 | 3.553435228689E−08 | 6.960371848982E−09 | 1.171518947466E−13 |
| A8 | 1.912878990729E−09 | −1.069642907422E−10 | −6.677053224565E−17 |
| A9 | −2.194978720910E−10 | −2.515730990264E−12 | −2.495368412111E−19 |
| A10 | −7.046341580100E−13 | 9.543258835658E−14 | 1.541351685988E−22 |
| A11 | 6.375061000824E−13 | 2.090587944287E−16 | 3.276784187379E−25 |
| A12 | −1.597777413310E−14 | −3.119783065887E−17 | −2.090956856696E−28 |
| A13 | −1.103817973809E−15 | 2.056672728575E−20 | −2.512006300989E−31 |
| A14 | 5.357982510139E−17 | 5.534340015371E−21 | 1.703227765455E−34 |
| A15 | 1.134375429414E−18 | −3.489870435134E−24 | 1.100954128990E−37 |
| A16 | −7.629084155544E−20 | −5.641022157270E−25 | −8.172918722492E−41 |
| A17 | −6.295191195142E−22 | 3.624683809890E−29 | −2.555586253598E−44 |
| A18 | 5.107419451195E−23 | 3.134721062690E−29 | 2.127530859381E−47 |
| A19 | 1.444201423363E−25 | 7.578861629635E−33 | 2.432326343871E−51 |
| A20 | −1.311289854757E−26 | −7.452150182979E−34 | −2.316923013156E−54 |

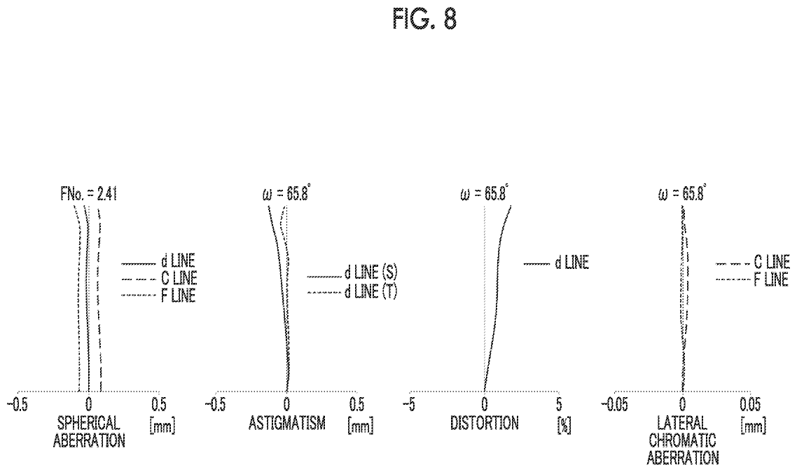

FIG. 8 shows each aberration diagram of the projection optical system of Example 1. In FIG. 8, in order from the left side, spherical aberration, astigmatism, distortion, and lateral chromatic aberration are shown. In the spherical aberration diagram, aberrations at the d line, C line, and F line are indicated by the solid line, the long dashed line, and the short dashed line, respectively. In the astigmatism diagram, the aberration at the d line in the sagittal direction is indicated by a solid line, and the aberration at the d line in the tangential direction is indicated by the short dashed line. In the distortion diagram, aberration at the d line is indicated by the solid line. In lateral chromatic aberration diagram, aberrations at the C line and the F line are indicated by the long dashed line and the short dashed line, respectively. In spherical aberration diagram, FNo. indicates an F number. In the other aberration diagrams, ω indicates a half angle of view. FIG. 8 shows data in a case where the distance from the projection surface to the lens surface closest to the magnification side is 752.7.

Symbols, meanings, description methods, and illustration methods of the respective data pieces according to examples and modification examples are the same as those in the following examples unless otherwise noted. Therefore, in the following description, repeated description will be omitted.

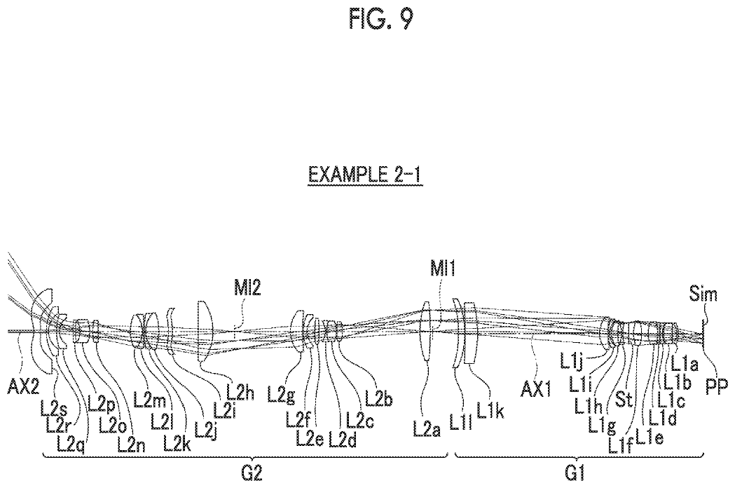

The projection optical systems of Examples 2-1 and 2-2 each have a linear optical path. FIG. 9 shows a cross-sectional view of a lens configuration and rays of the projection optical system of Example 2-1. The projection optical system of Example 2-1 consists of a first optical system G1 and a second optical system G2, in order from the reduction side to the magnification side. The first optical system G1 consists of lenses L1a to L1f, an aperture stop St, and lenses L1g to L1l, in order from the reduction side to the magnification side. The second optical system G2 consists of lenses L2a to L2s in order from the reduction side to the magnification side.

The projection optical system of Example 2-1 forms two intermediate images inside the projection optical system. The first intermediate image MI1 is formed between the lens L1l and the lens L2a. The second intermediate image MI2 is formed between the lens L2g and the lens L2h. The first optical system G1 is a coaxial system, and all the lenses of the first optical system G1 have the first optical axis AX1 in common. The second optical system G2 is a coaxial system, and all the lenses of the second optical system G2 have a second optical axis AX2 in common. The first optical axis AX1 and the second optical axis AX2 are parallel.

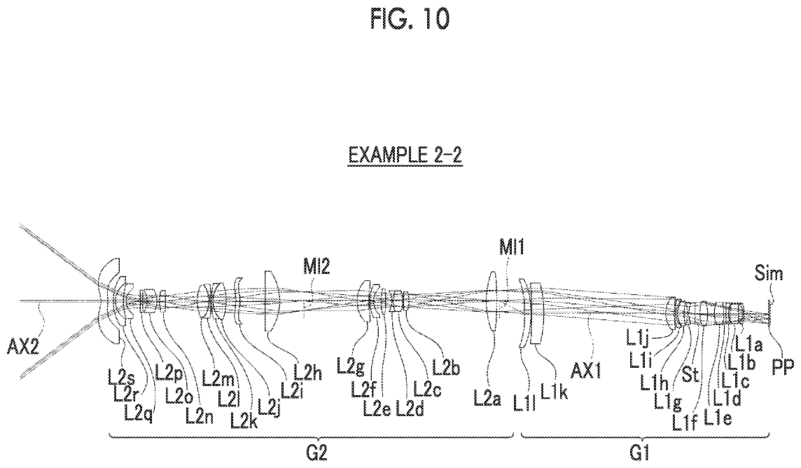

FIG. 10 shows a cross-sectional view of a lens configuration and rays of the projection optical system of Example 2-2. Each lens of Example 2-2 is the same as each lens of Example 2-1. The projection optical system of Example 2-2 is an optical system in which the amount of deviation between the first optical axis AX1 and the second optical axis AX2 is increased from the projection optical system of Example 2-1.

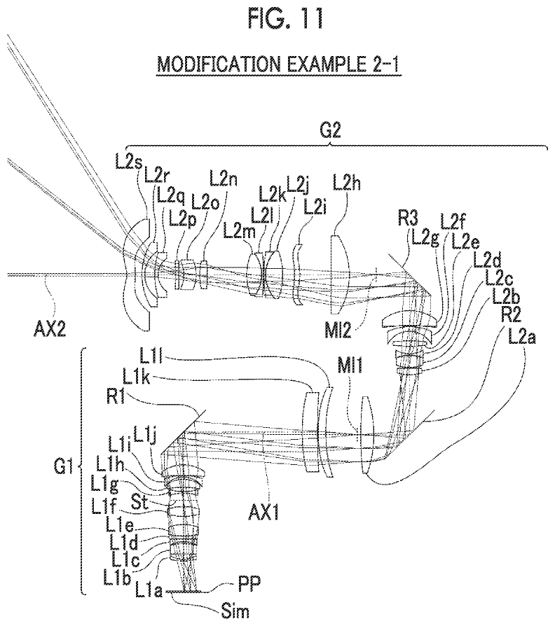

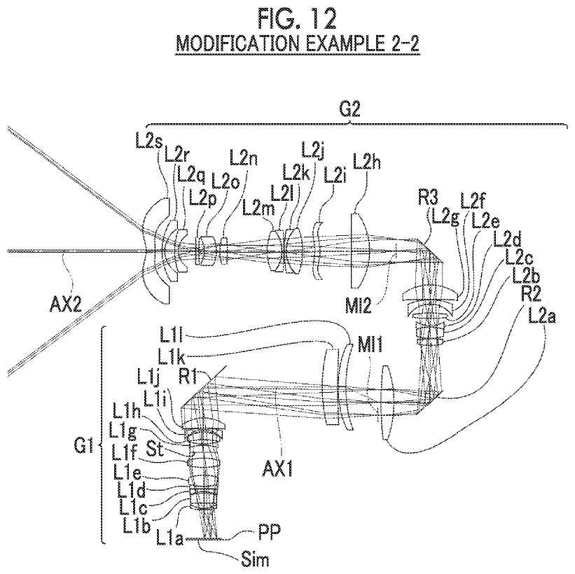

The projection optical systems of Modification Examples 2-1 and Modification Examples 2-2 each have a bent optical path. FIG. 11 shows a lens configuration and rays of Modification Example 2-1. Modification Example 2-1 has a configuration in which three optical path deflecting members are added to the projection optical system of Example 2-1 and the optical path is deflected three times. FIG. 12 shows a lens configuration and rays of Modification Example 2-2. Modification Example 2-2 has a configuration in which three optical path deflecting members are added to the projection optical system of Example 2-2 and the optical path is deflected three times. In both Modification Example 2-1 and Modification Example 2-2, a mirror R1 that deflects the optical path 90 degrees is disposed between the lens L1j and the lens L1k, a mirror R2 that deflects the optical path 90 degrees is disposed between the lens L2a and the lens L2b, and a mirror R3 that deflects an optical path by 90 degrees is disposed between the lens L2g and the lens L2h.

Next, numerical data will be shown. Hereinafter, for convenience of explanation, a projection optical system in which the first optical axis AX1 and the second optical axis AX2 of Example 2-1 are aligned on the same straight line is shown as the “projection optical system of Example 2”. The projection optical system of Example 2 is also a projection optical system in which the first optical axis AX1 and the second optical axis AX2 of Example 2-2 are aligned on the same straight line.

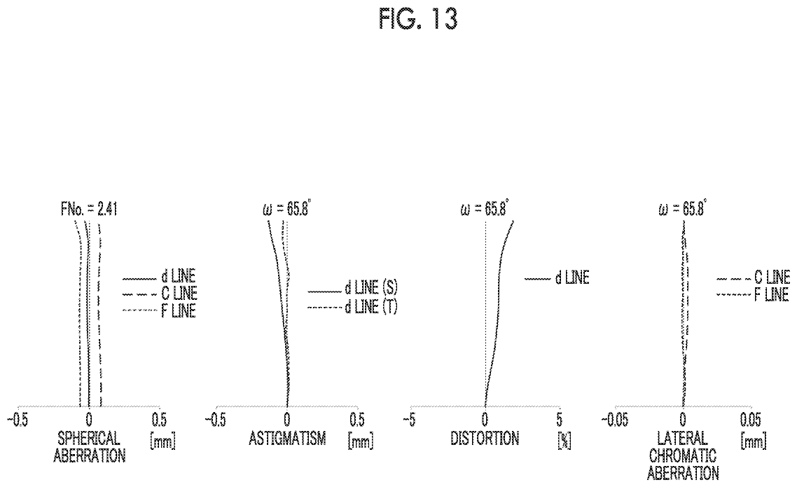

Regarding the projection optical system of Example 2, Tables 4A and 4B show basic lens data, Table 5 shows specification, Table 6 shows aspherical coefficients thereof, and FIG. 13 shows aberration diagrams. Table 4A shows the second optical system G2, and Table 4B shows the first optical system G1 and the optical member PP. FIG. 13 shows data in a case where the distance from the projection surface to the lens surface closest to the magnification side is 752.7.

TABLE 4A

| Sn | R | D | Nd | vd |
|---|---|---|---|---|
| *1 | −14.0588 | 5.6000 | 1.53158 | 55.08 |
| *2 | −26.4697 | 4.4258 | | |
| 3 | 42.7785 | 1.8000 | 1.72916 | 54.68 |
| 4 | 18.9302 | 6.5607 | | |
| 5 | 50.1385 | 2.2500 | 1.83400 | 37.16 |
| 6 | 13.7321 | 11.5529 | | |
| 7 | −201.1391 | 1.9107 | 1.84666 | 23.78 |
| 8 | 150.8962 | 3.4987 | | |
| 9 | −19.5578 | 7.9940 | 1.83481 | 42.74 |
| 10 | −24.2582 | 2.3199 | | |
| 11 | 40.1944 | 4.8496 | 1.80518 | 25.46 |
| 12 | −127.7087 | 26.0220 | | |
| 13 | 37.1255 | 9.7581 | 1.49700 | 81.54 |
| 14 | −23.8095 | 1.3000 | 1.84666 | 23.78 |
| 15 | −153.7402 | 0.1004 | | |
| 16 | 81.1553 | 1.2500 | 1.84666 | 23.78 |
| 17 | 23.6127 | 10.8721 | 1.49700 | 81.54 |
| 18 | −46.1147 | 7.8565 | | |
| *19 | −41.3926 | 3.4000 | 1.51007 | 56.24 |
| *20 | −32.1350 | 20.5106 | | |
| 21 | 22552.2237 | 12.0005 | 1.84666 | 23.78 |
| 22 | −49.4148 | 63.3114 | | |
| 23 | 28.1241 | 10.0001 | 1.80400 | 46.58 |
| 24 | 199.5046 | 0.4000 | | |
| 25 | 33.7023 | 3.0795 | 1.84666 | 23.78 |
| 26 | 16.3041 | 6.3639 | | |
| 27 | 77.7060 | 3.5861 | 1.80518 | 25.46 |
| 28 | −80.5608 | 5.1258 | | |
| 29 | −16.9315 | 1.0100 | 1.54072 | 47.23 |
| 30 | 25.1382 | 7.9615 | 1.49700 | 81.54 |
| 31 | −25.4582 | 0.4008 | | |
| 32 | 123.6194 | 4.5467 | 1.49700 | 81.54 |
| 33 | −27.4504 | 63.3385 | | |
| 34 | 80.0167 | 8.5671 | 1.84666 | 23.78 |
| 5 | −239.0637 | 22.9674 | | |

TABLE 4B

| Sn | R | D | Nd | vd |
|---|---|---|---|---|
| *36 | −119.2955 | 5.0000 | 1.53158 | 55.08 |
| *37 | −98.9047 | 0.5000 | | |
| 38 | −387.6852 | 10.0000 | 1.84666 | 23.78 |
| 39 | −117.4499 | 99.3855 | | |
| 40 | 23.3278 | 7.0378 | 1.69350 | 53.20 |
| 41 | 117.5795 | 0.1010 | | |
| 42 | 39.2104 | 1.0010 | 1.63930 | 44.87 |
| 43 | 14.9479 | 1.4878 | | |
| 44 | 18.3976 | 5.3678 | 1.62041 | 60.29 |
| 45 | 56.2901 | 2.8343 | | |
| 46 | −32.6703 | 0.9999 | 1.67270 | 32.10 |
| 47 | 28.7462 | 4.9366 | | |
| 48(St) | ∞ | 4.0000 | | |
| 49 | 31.6271 | 6.5511 | 1.49700 | 81.54 |
| 50 | −36.5073 | 5.4018 | | |
| 51 | 27.6398 | 7.7218 | 1.77250 | 49.60 |
| 52 | −44.6958 | 0.1010 | | |
| 53 | −41.0493 | 1.6631 | 1.56732 | 42.82 |
| 54 | 191.3876 | 0.2920 | | |
| 55 | 1724.0944 | 1.7768 | 1.67270 | 32.10 |
| 56 | 19.5262 | 1.0583 | | |
| 57 | 29.3698 | 6.9779 | 1.84666 | 23.78 |
| 58 | 169.3627 | 3.7548 | | |
| 59 | −14.8108 | 1.0008 | 1.51742 | 52.43 |
| 60 | −32.0855 | 20.0002 | | |
| 61 | ∞ | 1.0500 | 1.51633 | 64.14 |
| 62 | ∞ | 0.0377 | | |

TABLE 5

| | |
|---|---|
| \|f\| | 5.02 |
| FNo. | 2.41 |
| 2ω(°) | 131.6 |
| Ymax | 23 |

TABLE 6

| Sn | 1 | 2 | 19 |
|---|---|---|---|
| KA | −7.101284032400E−03 | −5.152812450800E−02 | 0.000000000000E+00 |
| A3 | 8.024293900952E−04 | 1.048862486198E−03 | 0.000000000000E+00 |
| A4 | 2.463810199685E−04 | 4.514349839930E−05 | 4.466001164567E−05 |
| A5 | −1.652380725085E−05 | 1.380105681013E−04 | −1.973400019333E−06 |
| A6 | −1.564149007481E−07 | −1.745340803638E−06 | −2.545506534834E−07 |
| A7 | 4.778113939713E−08 | 1.557445780663E−09 | 3.482176071196E−08 |
| A8 | −6.387553563677E−10 | 7.391565110555E−09 | 1.097193419631E−09 |
| A9 | −8.032057217774E−11 | −1.813187827118E−10 | −1.666311045271E−10 |
| A10 | 2.128994209583E−12 | −1.596427340152E−11 | −2.183922285426E−12 |
| A11 | 8.163016111106E−14 | 6.392600315665E−13 | 3.846422115295E−13 |
| A12 | −3.063516125008E−15 | 1.627391397084E−14 | 2.381230689409E−15 |
| A13 | −4.993047346837E−17 | −9.592653230925E−16 | −4.850818626728E−16 |
| A14 | 2.521900546436E−18 | −6.256643493260E−18 | −1.368544353320E−18 |
| A15 | 1.721754641362E−20 | 7.341316150595E−19 | 3.415843739642E−19 |
| A16 | −1.228814561369E−21 | −1.558971722576E−21 | 3.284381190625E−22 |
| A17 | −2.776263493323E−24 | −2.822367341563E−22 | −1.260686349673E−22 |
| A18 | 3.322694446891E−25 | 1.950126249257E−24 | 1.094573589980E−26 |
| A19 | 9.624360629121E−28 | 4.324565361048E−26 | 1.900113932238E−26 |
| A20 | −3.871004961595E−29 | −4.269264282294E−28 | −1.200331104963E−29 |
| Sn | 20 | 36 | 37 |
| KA | −2.674020696800E+00 | −1.228654870400E+00 | 7.427465330000E−01 |
| A3 | 0.000000000000E+00 | 0.000000000000E+00 | 0.000000000000E+00 |
| A4 | 4.059327581121E−05 | −8.615553865943E−06 | −1.229448844607E−06 |
| A5 | −3.546563505460E−07 | 1.608540306944E−06 | −1.670718844252E−08 |
| A6 | −3.543451093567E−07 | −1.534513052763E−07 | 1.556208771734E−11 |
| A7 | 3.337477078346E−08 | 6.960371848982E−09 | 1.171518947466E−13 |
| A8 | 1.275956464268E−09 | −1.069642907422E−10 | −6.677053224565E−17 |
| A9 | −1.707747774312E−10 | −2.515730990264E−12 | −2.495368412111E−19 |
| A10 | −7.098794834667E−13 | 9.543258835658E−14 | 1.541351685988E−22 |
| A11 | 4.582894750172E−13 | 2.090587944287E−16 | 3.276784187379E−25 |
| A12 | −9.350616668019E−15 | −3.119783065887E−17 | −2.090956856696E−28 |
| A13 | −7.698113644880E−16 | 2.056672728575E−20 | −2.512006300989E−31 |
| A14 | 3.317175884509E−17 | 5.534340015371E−21 | 1.703227765455E−34 |
| A15 | 7.839143998207E−19 | −3.489870435134E−24 | 1.100954128990E−37 |
| A16 | −4.795025913275E−20 | −5.641022157270E−25 | −8.172918722492E−41 |
| A17 | −4.329536439012E−22 | 3.624683809890E−29 | −2.555586253598E−44 |
| A18 | 3.202485268604E−23 | 3.134721062690E−29 | 2.127530859381E−47 |
| A19 | 9.864685597424E−26 | 7.578861629635E−33 | 2.432326343871E−51 |
| A20 | −8.119334724065E−27 | −7.452150182979E−34 | −2.316923013156E−54 |

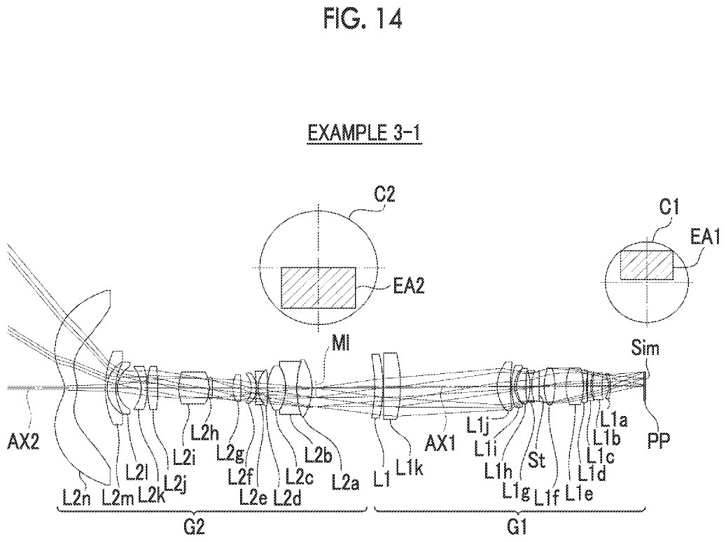

FIG. 14 shows a cross-sectional view of a lens configuration and rays of the projection optical system of Example 3-1. The projection optical system of Example 3-1 consists of a first optical system G1 and a second optical system G2, in order from the reduction side to the magnification side. The first optical system G1 consists of lenses L1a to L1f, an aperture stop St, and lenses L1g to L1l, in order from the reduction side to the magnification side. The second optical system G2 consists of lenses L2a to L2n in order from the reduction side to the magnification side.

The projection optical system of Example 3-1 forms one intermediate image MI inside the projection optical system. The intermediate image MI is formed between the lens L1l and the lens L2a. The first optical system G1 is a coaxial system, and all the lenses of the first optical system G1 have the first optical axis AX1 in common. The second optical system G2 is a coaxial system, and all the lenses of the second optical system G2 have a second optical axis AX2 in common. The first optical axis AX1 and the second optical axis AX2 are parallel.

Similarly to FIG. 4, FIG. 14 shows the image circle C1 and the usable area EA1 of the first optical system G1, the image circle C2 of the second optical system G2, and the usable area EA2. The usable area EA1 in FIG. 14 is located above the center of the image circle C1 and away from the center. That is, the usable area EA1 is located above the first optical axis AX1. The usable area EA2 is located in the lower half of the image circle C2. The upper end of the usable area EA2 is located on the second optical axis AX2. That is, in the example shown in FIG. 14, the image displayed on the image display surface is not located on the first optical axis AX1. However, the projection image is located on the second optical axis AX2.

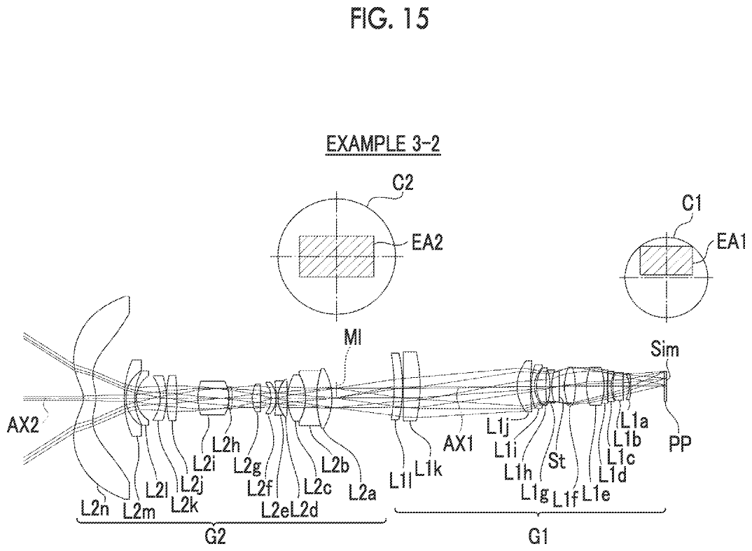

FIG. 15 shows a cross-sectional view of a lens configuration and rays of the projection optical system of Example 3-2. Each lens of Example 3-2 is the same as each lens of Example 3-1. The projection optical system of Example 3-2 is an optical system in which the relative deviation amount between the first optical axis AX1 and the second optical axis AX2 is increased from the projection optical system of Example 3-1.

Similarly to FIG. 4, FIG. 15 shows the image circle C1 and the usable area EA1 of the first optical system G1, the image circle C2 of the second optical system G2, and the usable area EA2. The usable area EA1 in FIG. 15 is located above the first optical axis AX1. The usable area EA2 is located in the lower half of the image circle C2. The center of the usable area EA2 coincides with the center of the image circle C2. That is, in the example shown in FIG. 15, the image displayed on the image display surface is not located on the first optical axis AX1. However, the center of the projection image is located on the second optical axis AX2.

Next, numerical data will be shown. Hereinafter, for convenience of explanation, a projection optical system in which the first optical axis AX1 and the second optical axis AX2 of Example 3-1 are aligned on the same straight line is shown as “projection optical system of Example 3”. The projection optical system of Example 3 is also a projection optical system in which the first optical axis AX1 and the second optical axis AX2 of Example 3-2 are aligned on the same straight line.

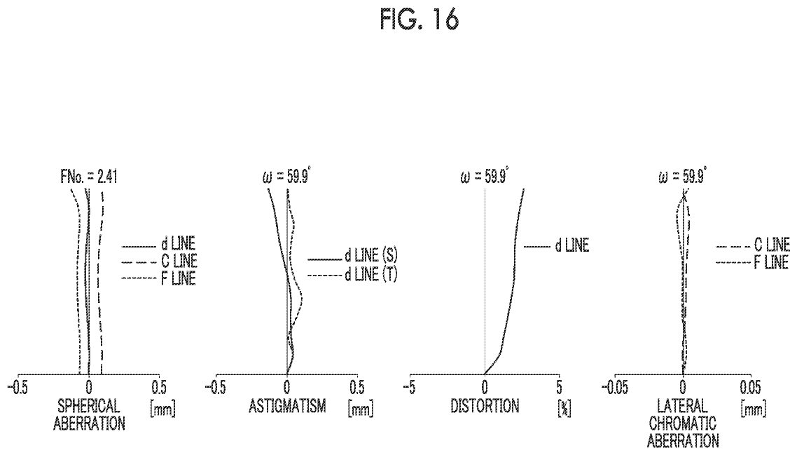

Regarding the projection optical system of Example 3, Tables 7A and 7B show basic lens data, Table 8 shows specification, Table 9 shows aspherical coefficients thereof, and FIG. 16 shows aberration diagrams. FIG. 16 shows data in a case where the distance from the projection surface to the lens surface closest to the magnification side is 970.0.

TABLE 7A

| Sn | R | D | Nd | vd |
|---|---|---|---|---|
| *1 | −8.7152 | 7.5000 | 1.49023 | 57.49 |
| *2 | −13.6055 | 16.8741 | | |
| 3 | 57.3204 | 1.0005 | 1.84666 | 23.78 |
| 4 | 19.0567 | 5.2256 | | |
| 5 | 32.5064 | 0.9994 | 1.83481 | 42.72 |
| 6 | 15.4717 | 14.2124 | | |
| 7 | −21.2853 | 3.7182 | 1.56384 | 60.67 |
| 8 | −42.4254 | 0.1010 | | |
| 9 | 61.3652 | 6.1347 | 1.84666 | 23.78 |
| 10 | −139.2375 | 12.6334 | | |
| 11 | 30.3817 | 18.1726 | 1.59551 | 39.24 |
| 12 | −21.3968 | 0.1282 | | |
| 13 | −21.2422 | 1.8314 | 1.84666 | 23.78 |
| 14 | −62.7427 | 12.1873 | | |
| 15 | 19.5715 | 4.9329 | 1.51680 | 64.20 |
| 16 | −119.9053 | 6.1106 | | |
| *17 | −20.2355 | 3.0000 | 1.51007 | 56.24 |
| *18 | −18.6670 | 0.1004 | | |
| 19 | −65.0618 | 0.9990 | 1.84666 | 23.78 |
| 20 | 16.2493 | 5.7121 | 1.49700 | 81.61 |
| 21 | −125.4119 | 0.0991 | | |
| 22 | 27.4767 | 10.7426 | 1.49700 | 81.61 |
| 23 | −27.3301 | 6.6551 | 1.83481 | 42.72 |
| 24 | 54.2029 | 0.0999 | | |
| 25 | 58.1761 | 9.0241 | 1.84666 | 23.78 |
| 26 | −34.6089 | 37.2149 | | |

TABLE 7B

| Sn | R | D | Nd | vd |
|---|---|---|---|---|
| *27 | −108.1077 | 5.0000 | 1.53158 | 55.08 |
| *28 | −91.3677 | 0.5000 | | |
| 29 | −2873.5774 | 9.9999 | 1.85025 | 30.05 |
| 30 | −90.9235 | 58.0029 | | |
| 31 | 24.1012 | 7.9183 | 1.65160 | 58.55 |
| 32 | 117.4920 | 0.6106 | | |
| 33 | 38.7953 | 1.7672 | 1.62004 | 36.26 |
| 34 | 15.2354 | 1.3331 | | |
| 35 | 18.6855 | 5.4300 | 1.62041 | 60.29 |
| 36 | 62.1836 | 2.5566 | | |
| 37 | −35.8925 | 1.0010 | 1.71736 | 29.52 |
| 38 | 27.6874 | 4.4862 | | |
| 39(St) | ∞ | 3.0000 | | |
| 40 | 30.9631 | 6.4311 | 1.49700 | 81.54 |
| 41 | −39.2949 | 6.6528 | | |
| 42 | 30.0352 | 10.4471 | 1.80400 | 46.53 |
| 43 | −38.1247 | 0.1004 | | |
| 44 | −35.2814 | 1.7991 | 1.56732 | 42.82 |
| 45 | 112.7114 | 0.6439 | | |
| 46 | −611.5020 | 1.7990 | 1.56732 | 42.82 |
| 47 | 20.3707 | 0.9905 | | |
| 48 | 30.4549 | 6.0456 | 1.84666 | 23.78 |
| 49 | 172.4413 | 3.7548 | | |
| 50 | −15.0312 | 1.0010 | 1.51742 | 52.43 |
| 51 | −36.6211 | 19.9995 | | |
| 52 | ∞ | 1.0500 | 1.51633 | 64.14 |
| 53 | ∞ | 0.0407 | | |

TABLE 8

| | |
|---|---|
| \|f\| | 6.32 |
| FNo. | 2.41 |
| 2ω(°) | 119.8 |
| Ymax | 23 |

TABLE 9

| Sn | 1 | 2 |
|---|---|---|
| KA | 1.751135996961E−02 | −2.418184606502E−01 |
| A3 | 2.889355298553E−03 | 2.046334909195E−03 |
| A4 | 2.915323441956E−05 | −1.507833650763E−05 |
| A5 | −6.212652571001E−06 | −1.560861175363E−07 |
| A6 | 1.429979807447E−07 | 1.819972556039E−08 |
| A7 | 4.495123062355E−09 | −4.333013732289E−09 |
| A8 | −2.461214393726E−10 | 1.011986323777E−10 |
| A9 | 2.828882656921E−13 | 5.160904686118E−12 |
| A10 | 1.790103434820E-13 | −1.742762247995E−13 |
| A11 | −2.461381789929E−15 | −2.792683764294E−15 |
| A12 | −6.349659023521E−17 | 1.281552596188E−16 |
| A13 | 1.614871588848E−18 | 7.675480476894E−19 |
| A14 | 8.198671781928E−21 | −5.211195550481E−20 |
| A15 | −4.912761975205E−22 | −8.805348703198E−23 |
| A16 | 1.209150319025E−24 | 1.219868494156E−23 |
| A17 | 7.416513592720E−26 | −2.093374130509E−27 |
| A18 | −4.773798373168E−28 | −1.542325148665E−27 |
| A19 | −4.479844956832E−30 | 9.232263665885E−31 |
| A20 | 3.997802860985E−32 | 8.179039819692E−32 |
| Sn | 17 | 18 |
| KA | −4.019280694847E−01 | 9.999961269066E−01 |
| A3 | 0.000000000000E+00 | 0.000000000000E+00 |
| A4 | −1.692291542648E−04 | −2.070176518362E−04 |
| A5 | −5.344893440825E−05 | 4.562160259289E−06 |
| A6 | 1.177702886024E−05 | −7.566518310665E−08 |
| A7 | −1.000793559588E−06 | 4.193822812039E−08 |
| A8 | −6.531729329294E−09 | 5.409117672085E−10 |
| A9 | 7.146816643570E−09 | 6.114906543537E−12 |
| A10 | −3.153438386350E−10 | −3.007782391460E−13 |
| Sn | 27 | 28 |
| KA | 9.999988565800E−01 | 9.999999507900E−01 |
| A3 | 0.000000000000E+00 | 0.000000000000E+00 |
| A4 | −2.462617548800E−06 | −1.467864210200E−07 |
| A5 | 4.410344934400E−07 | −6.386880817900E−10 |
| A6 | −3.950216763400E−08 | 1.446909996300E−13 |
| A7 | 1.797565798700E−09 | 2.180836272500E−15 |
| A8 | −3.251168173000E−11 | −1.545616782100E−19 |
| A9 | −3.283624746500E−13 | −9.878597359900E−22 |
| A10 | 1.814535964200E−14 | 1.015243474200E−25 |
| A11 | −2.017577480300E−17 | 2.708895618400E−28 |
| A12 | −4.099933216400E−18 | −3.792665150200E−32 |
| A13 | 9.692215901000E−21 | −4.655568543200E−35 |
| A14 | 5.112274787500E−22 | 8.236151277400E−39 |
| A15 | −9.527834790600E−25 | 4.776560995600E−42 |
| A16 | −3.677985683300E−26 | −1.031917418800E−45 |
| A17 | 3.900945475900E−29 | −2.664437377900E−49 |
| A18 | 1.438904271600E−30 | 6.923455002800E−53 |
| A19 | −5.759535857500E−34 | 6.205668571500E−57 |
| A20 | −2.387246835000E−35 | −1.927449266200E−60 |

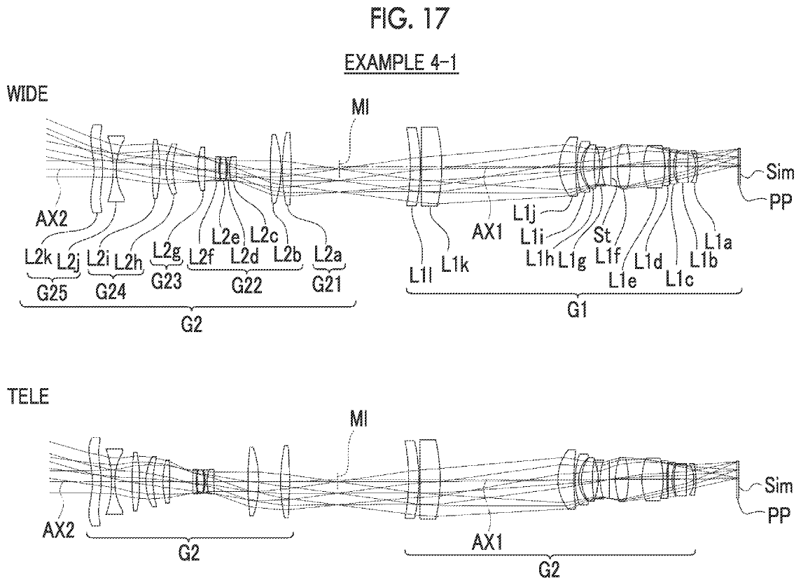

FIG. 17 shows a cross-sectional view of a lens configuration and rays of the projection optical system of Example 4-1. The projection optical system of Example 4-1 is a variable magnification optical system. In FIG. 17, the upper row labeled “WIDE” shows the configuration of the wide-angle end, and the lower row labeled “TELE” shows the configuration of the telephoto end. The projection optical system of Example 4-1 consists of a first optical system G1 and a second optical system G2, in order from the reduction side to the magnification side. The first optical system G1 consists of lenses L1a to L1f, an aperture stop St, and lenses L1g to L1l, in order from the reduction side to the magnification side. The second optical system G2 consists of a first lens group G21, a second lens group G22, a third lens group G23, a fourth lens group G24, and a fifth lens group G25 in order from the reduction side to the magnification side. Therefore, the distance between adjacent lens groups changes in a case where the magnification is changed. The first lens group G21 consists of a lens L2a. The second lens group G22 consists of lenses L2b to L2f in order from the reduction side to the magnification side. The third lens group G23 consists of a lens L2g. The fourth lens group G24 consists of lenses L2h to L2i in order from the reduction side to the magnification side. The fifth lens group G25 consists of lenses L2j to L2k in order from the reduction side to the magnification side.

The projection optical system of Example 4-1 forms one intermediate image MI inside the projection optical system. The intermediate image MI is formed between the lens L1l and the lens L2a. The first optical system G1 is a coaxial system, and all the lenses of the first optical system G1 have the first optical axis AX1 in common. The second optical system G2 is a coaxial system, and all the lenses of the second optical system G2 have a second optical axis AX2 in common. The first optical axis AX1 and the second optical axis AX2 are parallel.

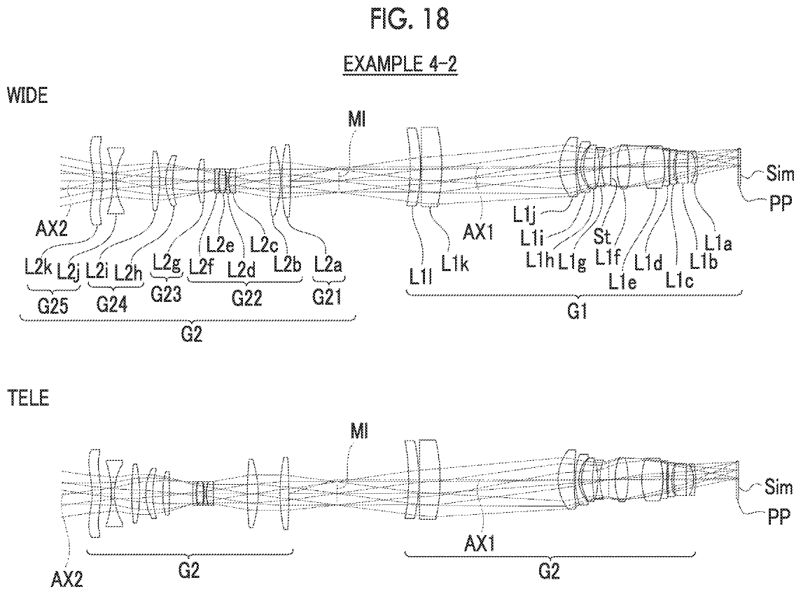

FIG. 18 shows a cross-sectional view of a lens configuration and rays of the projection optical system of Example 4-2. Each lens of Example 4-2 is the same as each lens of Example 4-1. The projection optical system of Example 4-2 is an optical system in which the amount of deviation between the first optical axis AX1 and the second optical axis AX2 is increased from the projection optical system of Example 4-1.

Next, numerical data will be shown. Hereinafter, for convenience of explanation, a projection optical system in which the first optical axis AX1 and the second optical axis AX2 of Example 4-1 are aligned on the same straight line is shown as “projection optical system of Example 4”. The projection optical system of Example 4 is also a projection optical system in which the first optical axis AX1 and the second optical axis AX2 of Example 4-2 are aligned on the same straight line.

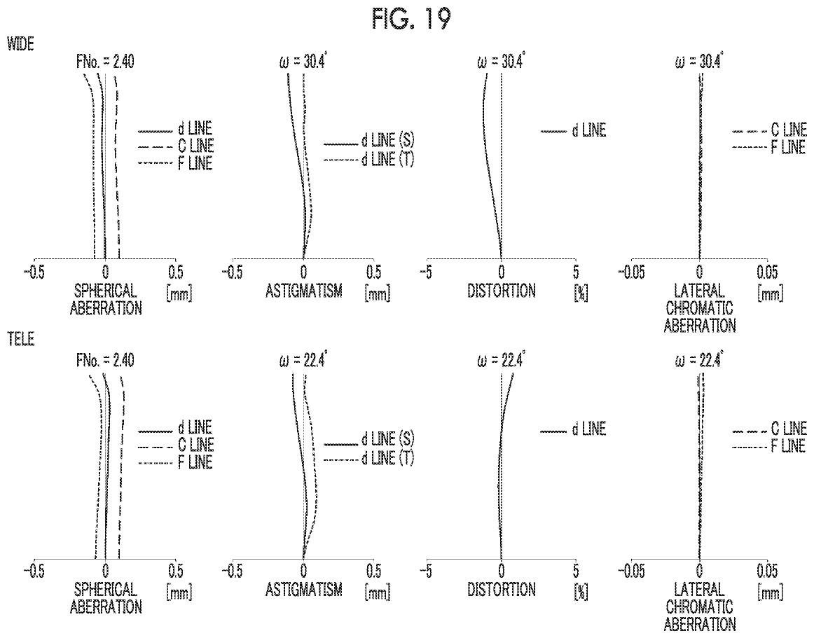

Regarding the projection optical system of Example 4, Tables 10A and 10B show basic lens data, Table 11 shows specification, Table 12 shows aspherical coefficients thereof, and FIG. 19 shows aberration diagrams. In Table 10A, the symbol DD [ ] is used for each variable surface distance during zooming, and the magnification side surface number of the distance is given in [ ] and is noted in the column D Table 11 shows the zoom ratio Zr, the absolute value of the focal length |f|, the F number FNo., the maximum total angle of view 2ω, the maximum image height Y max, and the variable surface distance during zooming, on the d line basis. (°) in the place of 2ω indicates that the unit thereof is a degree. In Table 11, the columns labeled WIDE and TELE show the values at the wide-angle end and the telephoto end, respectively. In FIG. 19, the upper row labeled “WIDE” shows aberration diagrams at the wide-angle end, and the lower row labeled “TELE” shows aberration diagrams at the telephoto end. FIG. 19 shows data in a case where the distance from the projection surface to the lens surface closest to the magnification side is 1630.0.

TABLE 10A

| Sn | R | D | Nd | vd |
|---|---|---|---|---|
| *1 | −31.5308 | 4.2857 | 1.49100 | 57.58 |
| *2 | −38.3561 | 5.1644 | | |
| 3 | −50.7137 | 1.4991 | 1.60311 | 60.64 |
| 4 | 29.2722 | DD[4] | | |
| 5 | 130.8496 | 3.8292 | 1.85025 | 30.05 |
| 6 | −78.8486 | 3.0615 | | |
| 7 | 27.2755 | 3.4656 | 1.80400 | 46.53 |
| 8 | 42.3286 | DD[8] | | |
| 9 | 40.1327 | 3.2702 | 1.72916 | 54.68 |
| 10 | −408.7433 | DD[10] | | |
| 11 | 315.9690 | 1.6071 | 1.80518 | 25.42 |
| 12 | 23.9382 | 0.5386 | | |
| 13 | 32.5934 | 3.1947 | 1.83481 | 42.74 |
| 14 | −27.1407 | 0.4270 | | |
| 15 | −20.5877 | 1.0000 | 1.80518 | 25.42 |
| 16 | 19.4141 | 3.2781 | 1.49700 | 81.61 |
| 17 | 67.8809 | 16.8615 | | |
| 18 | 162.4681 | 5.3050 | 1.83481 | 42.74 |
| 19 | −55.0552 | DD[19] | | |
| 20 | 85.8235 | 4.3458 | 1.84666 | 23.78 |
| 21 | −265.6122 | 58.7099 | | |

TABLE 10B

| Sn | R | D | Nd | vd |
|---|---|---|---|---|
| *22 | −108.1077 | 5.0000 | 1.53158 | 55.08 |
| *23 | −91.3677 | 0.5000 | | |
| 24 | −2873.5774 | 9.9999 | 1.85025 | 30.05 |
| 25 | −90.9235 | 58.0029 | | |
| 26 | 24.1012 | 7.9183 | 1.65160 | 58.55 |
| 27 | 117.4920 | 0.6106 | | |
| 28 | 38.7953 | 1.7672 | 1.62004 | 36.26 |
| 29 | 15.2354 | 1.3331 | | |
| 30 | 18.6855 | 5.4300 | 1.62041 | 60.29 |
| 31 | 62.1836 | 2.5566 | | |
| 32 | −35.8925 | 1.0010 | 1.71736 | 29.52 |
| 33 | 27.6874 | 4.4862 | | |
| 34(St) | ∞ | 3.0000 | | |
| 35 | 30.9631 | 6.4311 | 1.49700 | 81.54 |
| 36 | −39.2949 | 6.6528 | | |
| 37 | 30.0352 | 10.4471 | 1.80400 | 46.53 |
| 38 | −38.1247 | 0.1004 | | |
| 39 | −35.2814 | 1.7991 | 1.56732 | 42.82 |
| 40 | 112.7114 | 0.6439 | | |
| 41 | −611.5020 | 1.7990 | 1.56732 | 42.82 |
| 42 | 20.3707 | 0.9905 | | |
| 43 | 30.4549 | 6.0456 | 1.84666 | 23.78 |
| 44 | 172.4413 | 3.7548 | | |
| 45 | −15.0312 | 1.0010 | 1.51742 | 52.43 |
| 46 | −36.6211 | 19.9995 | | |
| 47 | ∞ | 1.0500 | 1.51633 | 64.14 |
| 48 | ∞ | 0.05 | | |

TABLE 11

| | WIDE | TELE |
|---|---|---|
| Zr | 1.0 | 1.7 |
| \|f\| | 19.59 | 27.26 |
| FNo. | 2.40 | 2.40 |
| 2ω(°) | 60.8 | 44.8 |
| Ymax | 23 | 23 |
| DD[4] | 17.61 | 8.54 |
| DD[8] | 12.23 | 4.90 |
| DD[10] | 5.23 | 11.47 |
| DD[19] | 0.60 | 10.77 |

TABLE 12

| Sn | 1 | 2 |
|---|---|---|
| KA | −9.997278016434E+00 | −9.978385606222E+00 |
| A3 | 0.000000000000E+00 | 0.000000000000E+00 |
| A4 | 9.649820782510E−06 | 2.772243901986E−05 |
| A5 | 2.069011213168E−06 | −4.131666082019E−07 |
| A6 | −1.498582459049E−07 | 7.668427617913E−08 |
| A7 | 3.759897133520E−09 | −1.186067452416E−08 |
| A8 | −3.360901623481E−11 | 4.086502314670E−10 |
| A9 | −5.232206466640E−12 | 1.121637818593E−11 |
| A10 | 7.040413924903E−13 | −3.295123724452E−13 |
| A11 | −2.428078052748E−14 | −3.819318898356E−14 |
| A12 | −1.370626171248E−16 | 2.157574480423E−16 |
| A13 | 1.858682850267E−17 | 1.027976388746E−16 |
| A14 | −1.595134885162E−19 | −2.551283138471E−18 |
| Sn | 22 | 23 |
| KA | 9.999988565800E−01 | 9.999999507900E−01 |
| A3 | 0.000000000000E+00 | 0.000000000000E+00 |
| A4 | −2.462617548800E−06 | −1.467864210200E−07 |
| A5 | 4.410344934400E−07 | −6.386880817900E−10 |
| A6 | −3.950216763400E−08 | 1.446909996300E−13 |
| A7 | 1.797565798700E−09 | 2.180836272500E−15 |
| A8 | −3.251168173000E−11 | −1.545616782100E−19 |
| A9 | −3.283624746500E−13 | −9.878597359900E−22 |
| A10 | 1.814535964200E−14 | 1.015243474200E−25 |
| A11 | −2.017577480300E−17 | 2.708895618400E−28 |
| A12 | −4.099933216400E−18 | −3.792665150200E−32 |
| A13 | 9.692215901000E−21 | −4.655568543200E−35 |
| A14 | 5.112274787500E−22 | 8.236151277400E−39 |
| A15 | −9.527834790600E−25 | 4.776560995600E−42 |
| A16 | −3.677985683300E−26 | −1.031917418800E−45 |
| A17 | 3.900945475900E−29 | −2.664437377900E−49 |
| A18 | 1.438904271600E−30 | 6.923455002800E−53 |
| A19 | −5.759535857500E−34 | 6.205668571500E−57 |
| A20 | −2.387246835000E−35 | −1.927449266200E−60 |

Table 13 shows the corresponding values of Conditional Expressions (1) to (7) of the projection optical systems of Examples 1 to 4. Table 14 shows the focal length f1 of the first optical system G1, the absolute value |f2| of the focal length of the second optical system G2, and the numerical values relating to Conditional Expression. Examples 1 to 4 use the d line as a reference wavelength, and Tables 13 and 14 show values based on the d line.

TABLE 13

| Expression | | | | | |
|---|---|---|---|---|---|
| Number | | Example 1 | Example 2 | Example 3 | Example 4 |
| (1) | Exp/Ymax | −1.857 | −1.857 | −1.861 | −1.861 |
| (2) | (Bf1 − Bf − Exp)/Ymax | 0.49 | 0.49 | 0.15 | 0.16 |
| (3) | Ymax/\|f\| | 4.58 | 4.58 | 3.64 | 1.17 |
| (4) | \|(Sr + Tr)/2\|/Ymax | 0.037 | 0.038 | 0.010 | 0.006 |
| (5) | \|f2/f\| | 2.23 | 2.23 | 1.43 | 1.43 |
| (6) | Bf2/\|f\| | −2.9 | 0.4 | 0.3 | 1.2 |
| (7) | Bf/\|f\| | 4.12 | 4.12 | 3.28 | 1.05 |

TABLE 14

| | Example 1 | Example 2 | Example 3 | Example 4 |
|---|---|---|---|---|
| f1 | 70.12 | 70.12 | 56.30 | 56.30 |
| \|f2\| | 11.17 | 11.17 | 9.02 | 28.10 |
| Bf | 20.7 | 20.7 | 20.7 | 20.5 |
| Bf1 | −10.8 | −10.8 | −18.7 | −18.7 |
| Bf2 | −14.7 | 1.9 | 1.9 | 23.0 |
| Exp | −42.7 | −42.7 | −42.8 | −42.8 |
| Sr | −294.4 × 10⁻³ | −306 × 10⁻³ | −101.1 × 10⁻³ | −103 × 10⁻³ |
| Tr | −1430.4 × 10⁻³ | −1429 × 10⁻³ | −340.8 × 10⁻³ | −160.7 × 10⁻³ |

As can be seen from the above data, the projection optical systems of Examples 1 to 4 are configured to be compact, but each aberration is satisfactorily corrected to realize high optical performance. In particular, the projection optical systems of Examples 1 and 2 each are configured to be compact while ensuring a wide angle of view of 130 degrees or more in all angles of view, thereby achieving high optical performance.

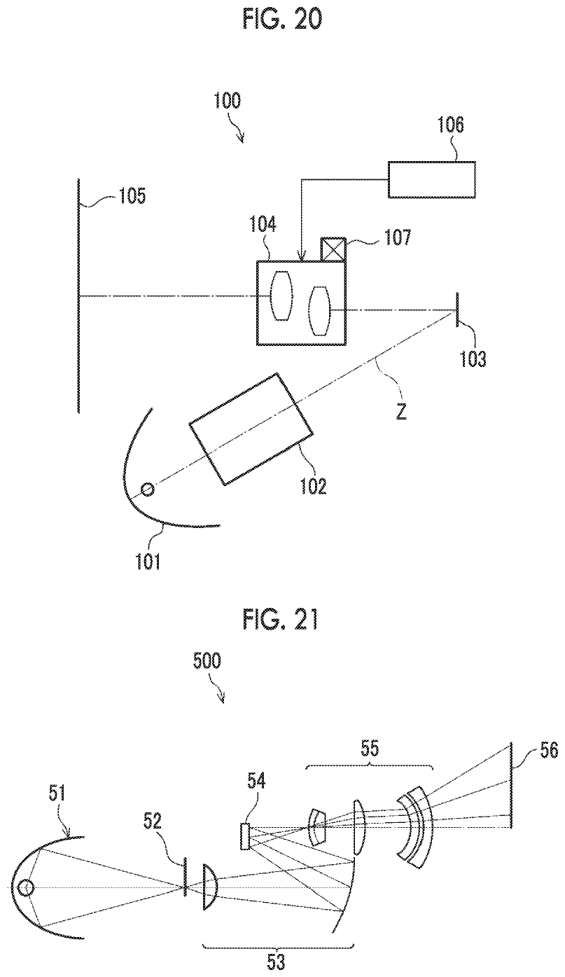

Next, a projection type display device according to an embodiment of the present disclosure will be described. FIG. 20 is a schematic configuration diagram of a projection type display device according to an embodiment of the present disclosure. The projection type display device 100 shown in FIG. 20 comprises a light source 101, an illumination optical system 102, a DMD 103 as an image display element, a projection optical system 104 according to an embodiment of the present disclosure, an optical axis control unit 106, and a lens shift mechanism 107. FIG. 20 conceptually shows the first optical system G1 and the second optical system G2. In the projection type display device 100, the relative positions of the first optical axis AX1 of the first optical system G1 and the second optical axis AX2 of the second optical system G2 are configured to be variable as described above with reference to FIG. 1. In FIG. 20, the reference numerals of the first optical axis AX1 and the second optical axis AX2 are omitted to avoid complication of the drawings. The optical axis control unit 106 controls at least one of the first optical axis AX1 or the second optical axis AX2 to change the amount of deviation between the first optical axis AX1 and the second optical axis AX2. In a case where the deviation amount is 0, the first optical axis AX1 and the second optical axis AX2 are on the same straight line. In a case where the deviation amount is other than 0, the first optical axis AX1 and the second optical axis AX2 are parallel.

In the projection type display device 100, the rays emitted from the light source 101 is selectively converted in chronological order into three primary color lights of red light, green light, and blue light by a color wheel which is not shown, and the rays are incident onto the DMD 103 after the light amount distribution is made uniform in the cross section perpendicular to the optical axis Z of the rays emitted by the illumination optical system 102. In the DMD 103, modulation switching for the colored light is performed in accordance with the color switching of the incident light. The light optically-modulated by the DMD 103 is incident onto the projection optical system 104. The projection optical system 104 projects an optical image of the optically-modulated light onto the screen 105. The lens shift mechanism 107 is controlled by a processor which is not shown to shift the projection optical system 104 with respect to the DMD 103 in a direction perpendicular to the optical axis. Thereby, the location of the projection image projected onto the screen 105 can be adjusted. Further, the optical axis control unit 106 is able to change the amount of deviation between the first optical axis AX1 and the second optical axis AX2. Thereby, it is also possible to adjust the location of the projection image projected onto the screen 105.

The technique of the present disclosure has been hitherto described through embodiments and examples, but the technique of the present disclosure is not limited to the above-mentioned embodiments and examples, and may be modified into various forms. For example, values such as the radius of curvature, the surface distance, the refractive index, the Abbe number, and the aspherical coefficient of each lens are not limited to the values shown in the numerical examples, and different values may be used therefor.

In addition, the projection type display device according to the technique of the present disclosure is not limited to the above configuration, and may be modified into various forms such as the optical member used for ray separation or ray synthesis and the image display element. The image display element is not limited to a form in which light from a light source is spatially modulated through an image display element and an image of the light based on image data is output as an optical image, but may be a form in which an image of light itself output from the self-luminous image display element based on the image data is output as an optical image. Examples of the self-luminous image display element include an image display element in which light emitting elements such as light emitting diodes (LED) or organic light emitting diodes (OLED) are two-dimensionally arranged.

Further, in the above embodiment, the case where the first optical system G1 and the second optical system G2 are both coaxial systems has been described. However, one or both of the first optical system G1 and the second optical system G2 may be configured to be non-coaxial systems. In such a configuration, the optical axis of the optical element closest to the magnification side in the first optical system is considered as the first optical axis, and the optical axis of the optical element closest to the reduction side in the second optical system is considered as the second optical axis.

What is claimed is:

1. A projection optical system that forms an intermediate image of an image displayed on an image display surface and forms a magnified image by projecting the intermediate image, the projection optical system consisting of, in order from a reduction side to a magnification side along an optical path,
a first optical system and a second optical system,
wherein the first optical system is telecentric on the magnification side,
wherein, in a case in which there are a plurality of optical systems which include an optical element closest to the reduction side in the projection optical system and which are telecentric on the magnification side, among the plurality of optical systems, an optical system in which a number of included optical elements is smallest is the first optical system,
wherein the first optical system is a coaxial system having a common first optical axis and is non-telecentric on the reduction side,
wherein the second optical system is a coaxial system having a common second optical axis and is telecentric on the reduction side, and
wherein the first optical axis and the second optical axis are parallel to each other.

2. The projection optical system according to claim 1, wherein assuming that
a distance on the first optical axis from a reduction side focal position of the projection optical system as a base point to a reduction side pupil position of the projection optical system is Exp,
a maximum image height on the reduction side of the projection optical system is Y max, and
a sign of the distance of Exp on the magnification side from the base point is negative and a sign of the distance of Exp on the reduction side from the base point is positive,
Conditional Expression (1) is satisfied, which is represented by
−5<Exp/Y max<−0.5 (1).

3. The projection optical system according to claim 1, wherein assuming that
an air conversion distance on the first optical axis from a surface closest to the reduction side in the first optical system as a base point to a reduction side focal position of the first optical system is Bf1,
an air conversion distance on the first optical axis from a surface closest to the reduction side in the projection optical system as a base point to a reduction side focal position of the projection optical system is Bf,
a distance on the first optical axis from the reduction side focal position of the projection optical system as a base point to a reduction side pupil position of the projection optical system is Exp, and
a sign of each distance of Bf1, Bf, and Exp on the magnification side from each base point is negative and a sign of the distance of Bf1, Bf, and Exp on the reduction side from each base point is positive,
Conditional Expression (2) is satisfied, which is represented by
−1.5<(Bf1−Bf−Exp)/Y max<1.5 (2).

4. The projection optical system according to claim 1, wherein assuming that
a maximum image height on the reduction side of the projection optical system is Y max,
a focal length of the second optical system is f2,
a focal length of the projection optical system is f,
a distance in a direction of the second optical axis to a sagittal image plane at an image height of Y max×|f2/f|×0.8 on the reduction side in the second optical system in a case where a paraxial imaging position on the reduction side in the second optical system is set as a base point in a state where the magnified image is located at infinity is Sr,
a distance in the direction of the second optical axis to the tangential image plane at the image height of Y max×|f2/f|×0.8 on the reduction side in the second optical system in a case where the paraxial imaging position on the reduction side in the second optical system is set as the base point in a state where the magnified image is located at infinity is Tr,
a sign of each distance of Sr and Tr on the magnification side from each base point is negative and a sign of the distance of Sr and Tr on the reduction side from each base point is positive, and
each value of f2 and f is set at a wide-angle end in a case where each optical system is a variable magnification optical system,
Conditional Expressions (3) and (4) are satisfied, which are represented by
0.47<Y max/|f| (3), and
0<|(Sr+Tr)/2|/Y max<0.1 (4).

5. The projection optical system according to claim 1, wherein assuming that
a focal length of the second optical system is f2,
a focal length of the projection optical system is f, and
each value of f2 and f is set at a wide-angle end in a case where each optical system is a variable magnification optical system,
Conditional Expression (5) is satisfied, which is represented by
0.6<|f2/f|<4 (5).

6. The projection optical system according to claim 1, wherein assuming that
an air conversion distance on the second optical axis from a surface closest to the reduction side in the second optical system as a base point to a reduction side focal position of the second optical system is Bf2,
a focal length of the projection optical system is f,
a sign of the distance of Bf2 on the magnification side from the base point is negative and a sign of the distance of Bf2 on the reduction side from the base point is positive, and
a value of f is set at a wide-angle end in a case where the projection optical system is a variable magnification optical system,
Conditional Expression (6) is satisfied, which is represented by
−5<Bf2/|f|<5 (6).

7. The projection optical system according to claim 1, wherein assuming that
an air conversion distance on the first optical axis from a surface closest to the reduction side in the projection optical system as a base point to a reduction side focal position of the projection optical system is Bf,
a focal length of the projection optical system is f,
a sign of the distance of Bf on the magnification side from the base point is negative and a sign of the distance of Bf on the reduction side from the base point is positive, and
a value of f is set at a wide-angle end in a case where the projection optical system is a variable magnification optical system,
Conditional Expression (7) is satisfied, which is represented by
0.5<Bf/|f|<10 (7).

8. The projection optical system according to claim 1, wherein the intermediate image is formed between the first optical system and the second optical system.

9. The projection optical system according to claim 2, wherein Conditional Expression (1-1) is satisfied, which is represented by
−4<Exp/Y max<−1 (1-1).

10. The projection optical system according to claim 3, wherein Conditional Expression (2-1) is satisfied, which is represented by
0<(Bf1−Bf−Exp)/Y max<1 (2-1).

11. The projection optical system according to claim 4, wherein Conditional Expression (3-1) is satisfied, which is represented by
0.84<Y max/|f| (3-1).

12. The projection optical system according to claim 4, wherein Conditional Expression (4-1) is satisfied, which is represented by
0<|(Sr+Tr)/2|/Y max<0.05 (4-1).

13. The projection optical system according to claim 5, wherein Conditional Expression (5-1) is satisfied, which is represented by
1<|f2/f|<3 (5-1).

14. The projection optical system according to claim 6, wherein Conditional Expression (6-1) is satisfied, which is represented by
−3<Bf2/|f|<3 (6-1).

15. The projection optical system according to claim 7, wherein Conditional Expression (7-1) is satisfied, which is represented by
0.8<Bf/|f|<5 (7-1).

16. A projection type display device comprising:
an image display element that outputs the image; and
the projection optical system according to claim 1.

17. A projection optical system comprising:
an image display element that outputs an image; and
a projection optical system that forms an intermediate image of the image and forms a magnified image by projecting the intermediate image,
wherein the projection optical system consists of a first optical system and a second optical system, in order from a reduction side to a magnification side along an optical path,
wherein the first optical system is telecentric on the magnification side,
wherein, in a case in which there are a plurality of optical systems which include an optical element closest to the reduction side in the projection optical system and which are telecentric on the magnification side, among the plurality of optical systems, an optical system in which a number of included optical elements is smallest is the first optical system,
wherein the first optical system is a coaxial system having a common first optical axis and is non-telecentric on the reduction side,
wherein the second optical system is a coaxial system having a common second optical axis and is telecentric on the reduction side, and
wherein a relative position of the first optical axis and the second optical axis is variable.
